(19) United States
(12) Patent Application Publication
(10) Pub. No.: US 2015/0204763 A1
(43) Pub. Date: Jul. 23, 2015

(54) SYSTEM FOR ANALYZING BIOLOGICAL SAMPLE MATERIAL

(71) Applicant: NMI Naturwissenschaftliches und Medizinisches Institut an der Universitaet Tuebingen, Reutlingen (DE)

(72) Inventors: Martin Stelzle, Reutlingen (DE); Julia Schuette, Tuebingen (DE); Werner Simon, Gomaringen (DE); Britta Hagmeyer, Tuebingen (DE); Massimo Kubon, Muensignen (DE)

(21) Appl. No.: 14/609,369

(22) Filed: Jan. 29, 2015

Related U.S. Application Data
(63) Continuation of application No. PCT/EP2012/064489, filed on Jul. 30, 2012.

(51) Int. Cl. G01N 1/30; G01N 1/31

(52) U.S. Cl. CPC G01N 1/30; G01N 1/31

(57) ABSTRACT

A system for carrying out analyses on and/or with biological sample material present in a sample arrangement region of a microfluidic sample chip comprises a connector plate for receiving the sample chip and a control unit to which the connector plate is detachably connectable for exchange of fluids and electrical signals.

### RELATED APPLICATION

This is a continuation application of copending international patent application PCT/EP2012/0644890, filed Jul. 30, 2012 and designating the United States, which was published in German as WO 2012/019603 A1. The entire content of the prior application is incorporated herein by reference.

### BACKGROUND OF THE INVENTION

1. Field of the Invention

The present invention relates to a system for carrying out analyses on and/or with biological sample material, in particular complex arrangements of cells.

The present invention further relates to the use of such systems in the analysis of and/or on biological sample material.

In addition to the analysis of naturally occurring cells, which optionally are assembled to organo-typical cell culture systems, the present invention also relates to analysis of and/or with tumor cells and cell lines.

2. Related Prior Art

In many areas of scientific research and diagnostics, whether in a research laboratory or in the everyday activity of a laboratory undertaking routine analyses, there is a need for complex arrangements of cells, which as far as possible are in physiological conditions, for example in the anatomically correct arrangement of the individual cell types relative to one another and/or can be physiologically functionally perfused.

An example of these complex arrangements of cells is determination of the toxicity and the metabolism of active substances in the pharmaceutical industry.

Therefore, there is a need for complex, organo-typical cell culture systems that consist of biological cells that grow in environments that allow differentiation over a correspondingly long period of time and/or a function comparable to the in vivo situation.

On the one hand, an organo-typical liver cell co-culture, with which active substances are to be tested for toxicity and metabolization, is of particular interest. The liver serves among other things for degradation and excretion of metabolic products, drugs and poisons, which reach the liver via the blood circulation. These substances are metabolized by the hepatocytes and removed in the bile. The bile produced by the liver goes via the hepatic duct system into the intestine and is excreted in this way. For an organo-typical liver cell culture for drug testing it is important that the hepatocytes are populated externally with endothelial cells, with perfusion of the complex cell culture taking place from the direction of the endothelial cells. Co-culture of hepatocytes with endothelial cells and optionally stellate cells ensures tissue-typical differentiation of the hepatocytes and the associated expression of genes that are required for metabolization of the stated substances.

Moreover, there is a need for an organo-typical tissue structure, such as can be found for example in the intestine. Once again, for physiologically functional perfusion it is necessary to differentiate between “inside” and “outside”. In the intestine, substances ingested are cleaved enzymatically and transported via the intestinal epithelium into the blood circulation. The intestinal epithelium consists of a monolayer epithelial layer, which faces the intestinal lumen, and an underlying layer of mesenchymal cells, which maintains the differentiation and function of the epithelial cells. Analyses of uptake of drugs on oral administration could be carried out on such a cell aggregation produced in vitro.

Another area of application is the so-called blood-brain barrier, which controls the movement of substances from the blood into the brain and ensures that the chemical composition of the intracellular fluids of the brain remains largely constant, which is necessary for precise signal transmission between the nerve cells of the central nervous system. Around blood vessels, the blood-brain barrier is formed by endothelial cells and astrocytes. They provide via active transport systems for the transfer of nutrients and oxygen or metabolites. In connection with the development of active substances, knowledge about the permeability of the blood-brain barrier to these active substances and therefore their availability in regions of the nervous system is of special interest.

In order to meet these requirements, DE 10 2008 018 170 B4 describes a microfluidic system, which serves for the construction and the subsequent culture of complex arrangements of cells. The system comprises several micro-channels, via which it can be perfused with a medium from outside. For this purpose the system is provided with connections for fluidic control.

By means of a special channel structure with openings, on which inhomogeneous electric fields are applied, complex organo-typical arrangements of cells can assemble at the openings in this microfluidic system.

Moreover, the microfluidic system is provided in different regions with different selective coatings, so as to have a specific influence on colonization with the cells. Colonization may be supported in certain regions with an adhesive coating, and avoided in other regions with a non-adhesive coating. Furthermore, coating with extracellular matrix (ECM) proteins may be provided, to support cell growth and cell differentiation. It is not described how this functionalization of the individual regions takes place.

In this system it is possible for example to produce an organo-typical liver tissue, in which hepatocytes and endothelial cells are settled in such a way that the hepatocytes are then completely surrounded externally by endothelial cells. After this complex structure has been established, it is then perfused with nutrient fluid through two micro-channels and therefore cultured for longer periods of time. If drugs are then added to the medium, they can be tested for toxicity and metabolization. It is advantageous that perfusion of the complex cell culture takes place from the direction of the endothelial cells, as is the case in intact liver tissue.

Various methods have been described in the prior art for carrying out locally resolved biofunctionalization of the internal surfaces of microfluidic systems. This functionalization is carried out before covering, i.e., closing the still open system, using for example spotting methods, lithographic methods or microcontact printing.

Such systems may be prepared according to DE 10 2009 039 956 A1, which is incorporated by reference herein, in such a way that they are compatible with the usual mass production methods, especially methods of covering for microfluidic systems, and yet allow locally resolved, three-dimensional biofunctionalization.

For this, a microfluidic system is provided, in which selected regions of the internal surfaces are selectively functionalized.

The inventors of DE 10 2009 039 956 A1 were able to show that it is possible, by irradiation with short-wave light, to functionalize any regions both of the carrier plate and of the cover plate and of the wall regions, so that complex cell structures can then be assembled in the closed system, as is described for example in above-mentioned DE 10 2008 018 170.

It is especially advantageous that it is also possible in this way to functionalize surface regions that are not parallel to the plane of the cover plate and/or carrier plate, which makes the later formation of complex, i.e., three-dimensional cell structures possible.

A further advantage is that the functionalization can be achieved quickly and easily, when the properties of the material surfaces of carrier plate, cover plate, wall regions are utilized to provide the non-functionalized regions without further process steps; then only the regions to be activated have to be irradiated. This applies in particular to polymer materials, in which UV irradiation causes the formation of acid groups. Other common materials for fluidic microsystems, such as glass, silicon or silicon nitride, must be made non-adhesive beforehand, which can be achieved for example by silanization with a hydrophobic silane.

A further advantage is that the selected functionalization makes a long storage life of the new systems possible. The acid groups produced by irradiation are in themselves already stable in storage for several months. However, filling the permanently closed system with appropriate gases or liquids and subsequent heat-sealing ensures an even much longer shelf life of the sterile-packaged systems.

In view of this prior art, there is a continuing need to provide microfluidic systems, which are suitable for the establishment and culture of simple and complex arrangements of cells, with additional properties and functions, so that they can be used not only in the research laboratory, but in a simple way also for mass analyses and high-throughput analyses, as used for example in drug screening.

Moreover, it should be possible to manipulate these microfluidic systems quickly and easily, with a structure that is of reliable design and of low cost.

“Microfluidic system” means, in the context of the present invention, a system that is produced using microsystem technology. Various methods that are used in microsystem technology are described for example in the textbook by W. Menz et al., “Microsystem Technology,” WILEY-VCH Verlag GmbH, Weinheim, 2001.

In microsystems, for example micromechanical, microoptical, microfluidic and/or microelectronic components are combined. Therefore in the English-speaking area, microsystems are also known as MEMS (Micro Electro Mechanical System), BioMEMS (Bio Micro Electro Mechanical Systems) or MOEMS (Micro Opto Mechanical System), in many publications also denoted as micromachines.

In many cases these microsystems also contain sensors and/or actuators.

The dimensions of the microsystems are in the micrometer range, and structural components on the microsystems may have dimensions in the submicrometer range.

Microsystems find application not only in classical areas such as electrical engineering, control technology and information technology, but also for example in medical technology, biotechnology and pharmacology. When the microsystems comprise channels or regions for receiving fluids, they are called microfluidic systems.

### SUMMARY OF THE INVENTION

In view of this prior art, one object of the present application is to provide a system of the type mentioned at the outset and elements thereof, which, with a structure that is of simple design and of low cost, is also suitable in the routine laboratory and for high-throughput measurements on microfluidic systems. In one application, the system should make it possible to establish organo-typical elements of liver, intestine, kidney, skin, lung, heart muscle, blood vessels, but also typical barrier systems such as blood-brain, intestine-blood, and air-lung.

According to the invention, this and other objects are achieved by a connector plate for a system for carrying out analyses on and/or with biological sample material, which connector plate comprises a mechanical receiving device for a microfluidic sample chip, in which the biological sample material to be analyzed is arranged and optionally cultured, external connecting elements, for detachably connecting the connector plate to a control unit to enable transfer of media and/or signals, internal connecting elements, to detachably connect the connector plate to the sample chip to enable transfer of media and/or signals, and preferably at least one functional element, which is arranged between the external and the internal connecting elements.

Moreover, this and other objects of the invention are achieved by a microfluidic sample chip, which is especially provided for the new connector plate, with at least one sample channel unit, in which sample channel unit a microfluidic sample arrangement region is provided, in which sample arrangement region biological sample material is arranged and optionally cultured, wherein the sample channel unit is provided with a connecting region for transferring media and/or signals, and preferably at least one functional element is arranged between the sample arrangement region and the connecting region.

Moreover, this and other objects of the invention are achieved by a system for carrying out analyses on and/or with biological sample material present in a sample arrangement region of the new sample chip, with the new connector plate for receiving the sample chip and with at least one control unit, to which the connector plate is detachably connectable for transferring media and/or signals.

The inventors of the present application have recognized that with a hierarchic arrangement of the individual elements of the new system, it is possible to take account of the different complexity of the individual elements and the different frequency of use and the different need for replacement.

With the detachable connections, media and signals can be exchanged between the individual elements of the system. The media include fluids with which the sample chips, especially the sample arrangement regions, are rinsed and with which nutrients, sample material or test substances are supplied, as well as gases, with which the sample chips, especially the sample arrangement regions, can be rinsed and flooded. The signals include electrical and optical signals as well as pressure signals.

The microfluidic sample chip, which can be a pure consumable material and is discarded after carrying out an analysis on particular biological sample material, is to be regarded as the hierarchically lowest element. A sample chip of this kind has for example a sample arrangement region, as is described in DE 10 2008 018 170 B4 mentioned at the outset, the contents of which reference is incorporated herein its entirety. Regarding basic details of the sample arrangement regions, reference is therefore made to DE 10 2008 018 170 B4 and to DE 10 2009 039 956 A1, which is also mentioned at the outset.

According to one embodiment of the invention, one or more sample channel units are arranged on the new sample chip, in which sample channel units in each case corresponding microfluidic sample arrangement regions are provided in parallel or in series.

In order to appropriately prepare (prime) the sample channel unit or the sample arrangement region provided therein, so that afterwards the biological sample material can be arranged therein, preferably a complex cell arrangement can be established, the sample chip is according to one object provided with a connecting region, via which it can be contacted detachably for transferring media and signals.

In this way it is possible first to introduce into the sample channel unit a solution for activating functionalized regions, then optionally feed rinsing solutions through, and finally cover the thus activated regions with corresponding biological material.

Via fluidic connectors, medium with biological sample material can be led through the sample channel unit, to collect the biological sample material in the sample channel units.

Via electrical contacts, electric fields may then be applied, which according to the previously described prior art result in complex arrangements of cells even from different cell species and types being established in the sample arrangement region, so that they can be cultured there.

Between the sample arrangement region and the connecting region, in one embodiment at least one functional element is arranged, via which for example electrical measuring signals or liquid measuring samples may be taken from the cultured sample material. For this, sensors and/or pumps may be integrated in the sample chip as functional elements.

These functional elements may also serve for gassing the biological sample and the fluidic controls, to ensure that all sample channel units on the sample chip are reliably filled with medium. For this, bubble traps may be integrated in the sample chip, to prevent the arrangements of cells being disturbed or altered by air bubbles.

The connection to the outside world, as it were, is the connector plate provided according to the invention, on which a mechanical receiving device is provided, in which a microfluidic sample chip can be inserted. The inserted sample chip is then in contact detachably, via its connecting region, with the internal connecting elements of the connector plate, so that the necessary media and signals can be supplied and fluid consumption material can be led away via the external connecting elements of the connector plate. Furthermore, measuring signals and liquid measuring samples may be taken from the respective sample arrangement regions via the external connecting elements.

Also on the connector plate, preferably at least one functional element is provided, which is arranged between the external and the internal connecting elements and serves for example for distributing the supplied liquids uniformly or in a controlled manner and correspondingly for controlling and assigning the electrical signals that are supplied and obtained.

A functional element is therefore to be understood in the context of the present invention as an element that is arranged on the connector plate between the external and internal connecting elements or on the sample chip between the sample arrangement region and the connecting region and optionally also in the sample arrangement region itself. In one configuration, a functional element acts actively or passively on media and/or signals that are exchanged between the external and internal connecting elements or between the sample arrangement region and the connecting region. In another configuration, functional elements may be configured as sensors, which serve for acquisition of measured values.

Whereas the microfluidic sample chip is not in every case reusable, the connector plate is reusable after carrying out a corresponding analysis on an inserted sample chip.

The connector plate is indeed a necessary constituent of the higher-level system, but is also itself an interchangeable element, so that different connector plates can be provided for different applications, requirements and sample chips, but in each case they are used in the system with the control unit that is provided.

This control unit is connected detachably to the connector plate, so that it can be connected successively to different connector plates.

The control unit serves for controlling the supply of the media and the feed-in of the signals and to control the outflow of the consumption material and the taking of liquid measuring samples and measuring signals and optionally to manage the storage thereof.

According to one object two different control units are provided, on the one hand a dielectrophoresis unit, which serves for priming the sample chip and for assembling the sample material in the sample arrangement region, and on the other hand a perfusion unit, which is used after arrangement of the sample material.

The dielectrophoresis unit may also be used for introducing various cell types successively into the sample arrangement region, so that organo-typical arrangements of cells are formed there, as is described in principle for laboratory use in DE 10 2008 018 170 B4, which was mentioned at the outset.

As soon as a corresponding connector plate or the sample chip provided on the connector plate is correspondingly provided with a biological sample to be analyzed, the dielectrophoresis unit is separated from the connector plate and now the perfusion unit used as a control unit is connected. The perfusion unit mainly serves for supplying the sample material with nutrient medium and for controlling the incubation of the sample material for a defined measuring time and for acquisition of electrical measured values and/or for taking liquid measuring samples. Furthermore, test substances may be supplied via the perfusion unit.

Both control units may be made embodied in one device, but it is advantageous if they are configured as separate devices.

Namely, the dielectrophoresis unit is as a rule the control unit with the more complex construction; following establishment of a complex cell arrangement in a sample chip, it can be reused for establishing a cell arrangement in another sample chip, whereas the sample chip prepared beforehand, which is still in “its” connector plate, is supplied, controlled and “acquired” for measurement via the perfusion unit continuously throughout the measuring period.

Therefore only one complex control unit is necessary for establishing the cell arrangement, namely the dielectrophoresis unit, whereas several perfusion units of simpler construction and therefore of lower cost are provided, for supplying sample chips prepared in each case in their connector plates and for taking measured values and measuring samples.

According to another object the at least one functional element in the connector plate and/or the sample chip is configured to perform at least one task that is selected from the group comprising the electrical and optical pre-processing, distribution and combining as well as interim storage of control and measuring signals, the storage, transport and distribution of liquids and gases, the separating of gaseous constituents from the liquids in active or passive bubble traps, the generating of electrical pulses, the generating of electrical and/or magnetic constant and/or alternating fields, as well as the transmission of pressure signals.

The at least one functional element may for example be configured for applying electrical pulses to cells present in the sample arrangement region for cell lysis, in order to disrupt these cells—optionally with addition of lysis reagents—and to be able to analyze their contents in the effluent. It may also serve for generating magnetic fields, which may be used, for example as pumps, for transporting liquids.

According to a further object the internal connecting elements of the connector plate are configured for bubble-free coupling to the sample chip and the external connecting elements are configured for bubble-free coupling to the control unit.

Here, it is advantageous that on insertion and connection of the sample chip, no disturbing air bubbles get into the sample arrangement regions, and that during coupling and decoupling of the connector plate on the control unit, no disturbing air bubbles get into the micro-channels of the connector plate, where they would have disturbing effects.

In one embodiment the receiving device has clamping elements for mechanical holding of the sample chip; preferably an optically thin cover is provided in the receiving device.

An advantage connected with these features is that the sample chip becomes accessible by simple measures for reflected-light or transmitted-light microscopy.

With the new sample chip and the new connector plate it is preferred if the at least one functional element is configured as an optically sensitive, electrical, chemical or biochemical sensor.

Here, it is advantageous that in-situ quality monitoring of the experiments being carried out and online acquisition of measured values are possible.

An “optically sensitive sensor” means, in the context of the present invention, both an optoelectronic sensor and a sensor that is based on purely optically working amplification effects.

In another embodiment, at least two electrodes are provided in the sample arrangement region for generating an electric field, wherein the electrodes are preferably configured for impedance measurement, further preferably for generating electrical pulses.

Here, it is advantageous that the electrodes can serve several purposes, which simplifies the mechanical structure of the sample chip.

In one embodiment the electrodes are configured as electrically conducting polymer electrodes.

This measure is also of constructive advantage, as the polymer electrodes can be integrated more easily in the sample chip than metal electrodes. For this it is only necessary to fill corresponding micro-channels with a solution with at least one conductive, polymerizable monomer, said micro-channels leading to regions intended for the formation of connecting points and electrodes, and leave the solution to harden. Hardening can take place by heat treatment, irradiation with UV light or other suitable measures.

Polymer electrodes can be produced for example with doped epoxy resins, or silicones (e.g., PDMS). For this, a conductive doping agent, for example graphene, carbon nanotubes or metal nanoparticles, is mixed with the monomer and a suitable crosslinking agent and the pasty solution are filled in the micro-channels. Hardening then takes place e.g., by an increase in temperature.

Polymer electrodes may also be produced with photocrosslinkable polyelectrolytes, e.g., with polydiallyldimethylammonium chlorides (PDADMAC) or poly-2-acrylamino-2-methyl-1-propanesulfonic acid (PAMPSA).

According to a further object at least one gap delimited by two webs is provided in the sample arrangement region, which gap connects two microfluidic channels together, and in which a separating structure is arranged, which preferably comprises a membrane with holes or a hydrogel.

In one embodiment the sample chip comprises a carrier substrate, in which the at least one sample channel unit is formed, and which is sealed with a cover, which is preferably of optically thin configuration at least in some regions.

Here, it is advantageous that the sample material in the sample arrangement region can be analyzed by optical methods.

According to one object the sample chip comprises at least one passive bubble trap with a membrane.

The microfluidic structure here is configured so that air bubbles migrate to the membrane, through which they can escape from the microfluidic system, because the membrane is permeable to gases.

With the new system, owing to the system hierarchy and modularity provided according to the invention and the properties and features provided according to the invention, it is possible for the first time for many applications and assays either to be carried out at all, or at least with efficiency and precision unattainable hitherto.

Such methods of analysis on and/or with biological sample material that can be carried out with the new system and its elements comprise the steps:
a) assembling the biological sample material in the sample arrangement region,
b) incubating the sample material with at least one substance, which is supplied via microfluidic channels, and
c) analyzing the sample material.

The new method makes reproducible analysis possible for small amounts of sample material under controlled conditions with quasi-continuous sampling over extended periods of time. It can therefore be carried out not only with the new system and its units but also generally with a system that has at least one microfluidic sample arrangement region, in which biological sample material can be arranged and optionally cultured.

A substance is, in the context of the present invention, both an active substance, for example in the form of a monomeric or polymeric compound or in the form of particles, whose qualitative and/or quantitative action on the sample material is to be analyzed, as well as further biological material whose interaction with the sample material is to be analyzed. Active pharmaceutical ingredients and potentially toxic substances also fall under this definition, as do for example tumor cells, whose invasion into the sample material is to be analyzed.

Furthermore, nutrients, culture media or other substances also fall under this definition, which serve for example for staining, for disrupting or for other chemical, biological, biochemical or physical effects on the sample material or on its supply of nutrients.

In one embodiment, in step a) at least one organ-like cell culture model is established in the sample arrangement region.

Here, it is advantageous that an analysis on cell culture models is possible in an in vivo-like situation, but with the possibility of continuous observation and obtaining of samples. The concentration of cellular products can be analyzed directly in the perfusate.

In a further embodiment, in step c), with at least one method of analysis, a property or change in property of the sample material is analyzed, which is selected from the metabolome, enzyme activity, proteome, genome, gene expression, secretion of markers, morphological phenomenon, cellular vitality, cell organelle function, interaction between cells, interaction between cells and the surroundings in the sample arrangement region, proliferation.

In step b) the cells are lysed for this for example by adding suitable substances, and in step c) the DNA, RNA or proteins are extracted and analyzed. These steps serve for rapid analysis of changes of the cell culture, which has the advantage that the degradation of DNA, RNA, and proteins is minimized in comparison with usual methods.

In step c), moreover, structural changes of proteins can be analyzed, for example different folding with accompanying alteration or even loss of functionality Furthermore, it is possible to analyze the formation or loss of cell-cell contacts for example at the blood-brain barrier (e.g., loss of tight junctions). It is also possible to observe the behavior of cells on the surfaces in the sample arrangement region, for example whether they spread or detach.

In another embodiment, in step c) the cells are disrupted electrically by means of electrodes integrated in the sample arrangement region.

Here, it is advantageous that it is unnecessary to use lysing reagents, which avoids contamination and effects on the evaluation. It is especially advantageous that the electrodes provided for assembly can also be used for electrical lysis, by using them to emit electrical pulses of suitable strength and duration.

According to one object, the method of analysis is selected from immunohistochemistry, microscopy, electron microscopy, staining of cell constituents, analysis of dissolved constituents by separation techniques (chromatography, electrophoresis, mass spectrometry), colorimetry, immunoassays, nucleic acid analysis, PCR (polymerase chain reaction), FISH (fluorescence in situ hybridization), DNA sequencing, spectroscopy methods (infrared spectroscopy, Raman spectroscopy, NMR spectroscopy, fluorescence spectroscopy, UV/VIS spectroscopy).

For analysis of dissolved constituents, for example the perfusate is analyzed.

Staining of cell constituents comprises for example the interaction of labeled antibodies with proteins, nuclear staining and staining of the cytosol (for example with calcein).

In a further embodiment, in step c) the qualitative and/or quantitative action of the at least one substance supplied on the sample material is analyzed.

This step makes it possible to determine the toxicity and/or efficacy of substances and to determine dose-time profiles. By repeated incubation with recovery phases, it is in addition possible to analyze the long-term action of active substances.

According to a further object, a comparative analysis is conducted on a sample material that is incubated with the substance, and a sample material that is not incubated with the substance or is incubated with another substance.

Here, it is advantageous that a comparative measurement on two identical cell cultures, one treated, one untreated, is possible. Owing to the very precisely controlled parameters, with the aforementioned advantages of the new method it is possible to obtain predictions about the action of substances that have not been achievable hitherto. This step can also be used for preliminary calibration of the system.

According to another object, in step a) a liver-like cell culture model is assembled and cultured, which is incubated in step b) with at least one potentially toxic substance, wherein in step c) the action of the substance on at least one cellular function is analyzed.

The cellular functions of the liver-like cell culture to be analyzed include in particular mitochondrial dysfunctions, induction or inhibition of cytochrome P450 enzymes, impairment of the transporter protein function, accumulation of reactive oxygen species, impairment of cell-cell interactions, immune reactions.

According to another object, in step a), tumor cells are assembled and cultured in an organ-like cell culture, which is incubated in step b) with at least one oncologic active substance, wherein in step c) a change of the cell culture is analyzed.

Here, it is advantageous that testing of active substances on oncologic material is possible, which proceeds under reproducible and controlled conditions with the advantages of the new method that are described above. One or more active substances may be applied in succession or simultaneously. Tumor growth or tumor shrinkage can be observed.

According to another object, in step a), a biological cell barrier in an organ-like cell culture is assembled and cultured, which in step b) is incubated with at least one active substance on one side of the cell barrier, wherein in step c) the concentration of the active substance on the other side of the cell culture is analyzed.

Here, it is advantageous that with the advantages of the new method that are described above, the ability of active substances to pass through barriers and the influence of active substances on the function of the barrier can be analyzed. Examples of barriers are blood-brain, intestine-blood, blood-urine, air-blood.

According to another object, in step a), biological cells are assembled and cultured in an organ-like cell culture, which is incubated in step b) with at least one pathogen, wherein in step c) the reaction of the cell culture to incubation with the at least one pathogen is analyzed.

Here, measurements of the interaction of pathogens with tissue are possible in a reproducible manner and with the advantages of the new method that are described above. Bacteria, viruses, and parasites are used as pathogens.

According to another object, in step a), biological cells are assembled and fixed in an organ-like cell culture, to which at least one stain is bound in step b), and in step c) the staining is analyzed by optical methods.

The stain itself may be a molecule that binds specifically to structures of the fixed cells, or a molecule that binds specifically to structures of the fixed cells is used, to which molecule the stain is bound in a second step. This step makes immunohistochemical staining of organ-like cell cultures possible.

According to another object, in step a), biological cells are assembled and fixed in an organ-like cell culture, which in step b) are dried and incubated with a contrast agent and are then embedded in a matrix, wherein in step c) the cells embedded in the matrix are removed and analyzed.

With the advantages of the new method that are described above, it is thus possible for example to prepare cells for electron microscopy.

According to another object, in step a), biological cells are assembled and cultured in an organ-like cell culture, which is incubated with tumor cells in step b), and in step c) the behavior of the tumor cells and of the cell culture is analyzed.

These steps make it possible to analyze the formation of metastases and the displacement of healthy cells. With the advantages of the new method that are described above, continuous analysis of tumor development is possible for the first time on the same tissue at different time points.

The interaction of the tumor cells with the cell culture is preferably supported by dielectrophoresis or is even brought about.

According to another object, in step a), biological cells are assembled and cultured in an organ-like cell culture, which is incubated in step b) with at least two active substances, and in step c) the behavior of the cell culture is analyzed.

Here, it is advantageous that sequential or parallel administration of active substances is possible, so that with the advantages of the new method that are described above it is possible to analyze the mutual effects of the active substances.

According to another object, in step a), in a first sample arrangement region, biological cells are assembled and cultured in a first organ-like cell culture, and in a second sample arrangement region, biological cells are assembled and cultured in a second organ-like cell culture, wherein in one embodiment the first and the second sample arrangement regions are connected fluidically in series, wherein in step b) the first cell culture is perfused with at least one active substance, and the second cell culture is perfused with the effluent of the first cell culture, and wherein in step c) the reaction of the second cell culture to perfusion with the effluent is analyzed.

According to this variant, two or more even different organ-like structures can be assembled and analyzed on one sample chip, wherein the various sample arrangement regions on the sample chip are configured differently and can be addressed electrically selectively. This is important for example for establishing an in-vivo-like kidney structure.

This configuration and other features of the new method make possible, for the first time, the reproducible analysis of the reaction of a downstream organ to the treatment of another organ with active substances. For example, the product of a first cell culture is analyzed for its action on subsequent cell cultures.

Further advantages can be taken from the description and the appended drawing.

It is to be understood that the features stated above and yet to be explained below are applicable not only in the combination given in each case, but also in other combinations or individually, without departing from the scope of the present invention.

### BRIEF DESCRIPTION OF THE DRAWINGS

Embodiments of the invention are presented in the appended drawing and are explained in more detail in the following description. In the figures:

FIG. 1 shows a schematic representation of the new system with control unit and connector plate;

FIG. 2 shows the basic structure, not to scale, of a sample chip, such as can be inserted into the connector plate from FIG. 1;

FIG. 3 shows the basic structure, not to scale, of a sample channel unit, as is provided on the sample chip from FIG. 2;

FIGS. 4A and 4B show embodiments, not to scale, of sample channel units according to FIG. 3;

FIG. 5 shows an embodiment, not to scale, for a sample arrangement region from the sample channel unit from FIGS. 4A-4B;

FIG. 6 shows in a perspective view, a specific embodiment for the connector plate from FIG. 1;

FIG. 7 shows a longitudinal section through a fluidic block of the connector plate from FIG. 6;

FIGS. 8A, 8B and 8C show a principle embodiment for a first functional element, which serves for generating an electric field in the sample arrangement region from FIG. 5;

FIG. 9 shows a perspective view of a detail from a sample chip produced by injection molding technology;

FIGS. 10A, 10B and 10C show various principle embodiments of splitting and combining locations, as are used in the sample channel unit from FIGS. 4A-4B;

FIGS. 11A, 11B and 11C show embodiments of functional elements that serve for coupling and degassing of the microfluidic channels in the sample channel unit from FIGS. 4A-4B;

FIG. 12 shows an embodiment for bubble-free coupling of the connector plate to the control unit;

FIGS. 13A and 13B show embodiments for assembling complex arrangements of cells in a sample arrangement region with a separating structure configured as hydrogel;

FIG. 14 shows an embodiment for assembling complex arrangements of cells in a sample arrangement region with a separating structure configured as membrane; and

FIGS. 15A and 15B show diagrams showing the acquisition of a) albumin and b) 6β-hydroxytestosterone formed by various cells in the sample chip from testosterone.

### DESCRIPTION OF PREFERRED EMBODIMENTS

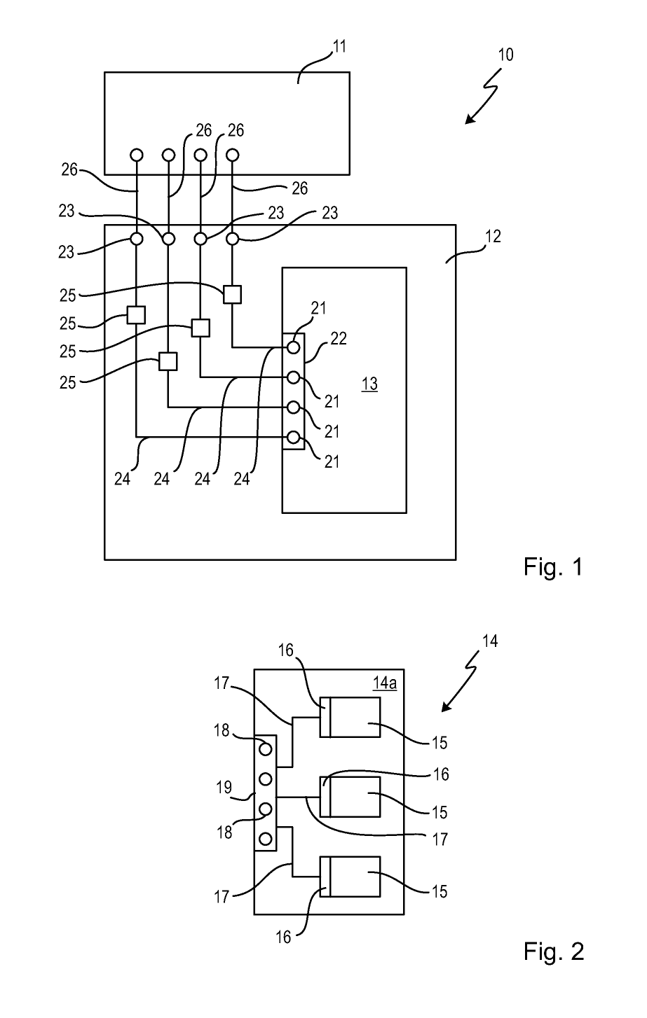

In FIG. 1, 10 denotes generally a system shown schematically and for carrying out analyses on biological sample material, which system consists of various elements.

The system 10 comprises, as first element, a control unit 11, to which various connector plates 12 are optionally connectable as second elements, to which various microfluidic sample chips 14 may be coupled as third elements each via a mechanical receiving device 13, for which sample chips an embodiment is shown in FIG. 2.

The receiving device 13 serves for operationally reliable anchoring of the sample chips 14 and the contacting thereof It further allows an optical analysis of biological sample material that can be assembled, cultured, incubated and perfused on the sample chips 14. For this, an optical analysis is possible by means of transmitted-light microscopy or at least by means of reflected-light microscopy.

The sample chip 14 from FIG. 2 comprises a carrier substrate 14a, on which for example three microfluidic sample channel units 15 are formed, which in each case have their own connecting region 16 for media and signals. In the simplest case each sample chip 14 contains one sample channel unit 15.

Each connecting region 16 is in particular connected via connecting lines 17 for media and signals to chip-connecting elements 18, which in the embodiment shown are arranged in a linear array 19.

The connecting elements 18 interact with internal connecting elements 21 of the connector plate 12, which are provided on the mechanical receiving region 13 of the connector plate 12 shown in FIG. 1. The internal connecting elements 21 are also arranged here as a linear array 22.

The connecting elements 18 serve in particular also for bubble-free connection of the sample chip 14 to the connector plate 12.

The internal connecting elements 21 are connected to external connecting elements 23 of the connector plate 12 via connecting lines 24 for media and signals.

The external connecting elements 23 serve in particular also for bubble-free coupling of the connector plate 12 to the control unit 11.

Between the external connecting elements 23 and the internal connecting elements 21, functional elements 25, shown schematically, are provided, which serve, in a manner yet to be described, for exerting an influence on the media and the signals that are exchanged between the sample channel units 15 and the external connecting elements 23. Functional elements 25 may also be configured for the acquisition of measuring signals.

The external connecting elements 23 are connected detachably to the control unit 11 via further connecting lines 26 for media and signals.

As already mentioned at the outset, the control unit 11 is e.g., a dielectrophoresis unit, which serves for arranging biological sample material, especially organo-typical arrangements of cells, in the sample channel units 15, as is known in principle for laboratory use from DE 10 2008 018 170 B4.

After the sample material has been arranged correspondingly in the sample channel units 15, the dielectrophoresis unit can be replaced with a perfusion unit, which now serves as control unit 11 and, during incubation of the sample material in the sample channel units 15, serves for supplying the sample material with medium and for delivering test substances. Moreover, measuring signals and liquid measuring samples are taken via the perfusion unit.

The functional elements 25 also serve for the processing and transmission of media and signals that are exchanged between the control unit 11 and the connecting regions 16 on the sample chips 14. This includes for example the electrical and optical preparation, distribution and merging as well as interim storage of control and measuring signals, the storage, transport and distribution of liquids and gases, the separating of gaseous constituents from the liquids in active or passive bubble traps, the transmission of pressure signals.

For this, the functional elements 25 may be configured as valves, multiplexers, pumps, heating devices, cooling devices.

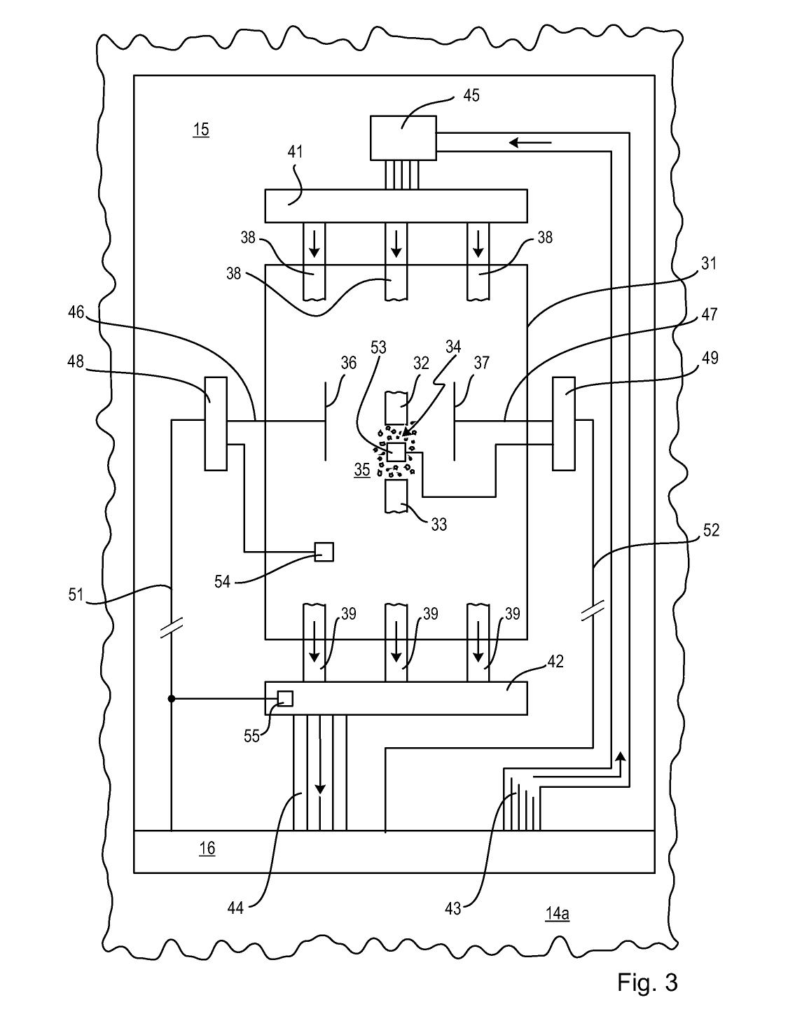

The principle structure of a sample channel unit 15 formed on the carrier substrate 14a is shown schematically in FIG. 3, simplified and not to scale.

The carrier substrate 14a consists entirely, or at least in the region of a microfluidic sample arrangement region 31 within the sample channel unit 15, of optically thin material, for example of polycarbonate (PC), cycloolefin copolymer (COC), polymethylmethacrylate (PMMA), polydimethylsiloxan (PDMS), or of glass or pure silicon. The carrier substrate 14 may be produced by molding, forming, lithographic processes, addition or removal of material or material components.

The sample arrangement region 31 has webs 32, 33, which delimit a gap 34, in which sample material 35 is collected.

For supporting the collection of sample material 35 in the gap 34, electrodes 36, 37 are provided, via which cells or other sample material are concentrated in the gap 34, which are led via microfluidic feed channels 38 into the sample arrangement region 31.

Opposite the feed channels 38, microfluidic outlet channels 39 are provided, via which flushed medium and liquid measuring samples optionally taken are led out.

A sample arrangement region 31 may be connected to one feed channel 38 and one outlet channel 39 or to several feed channels 38 and outlet channels 39.

The feed channels 38 are connected to a microfluidic functional region 41 and the outlet channels 39 are connected to a microfluidic functional region 42.

These functional regions 41, 42 comprise for example valve arrangements and branching structures, in order to ensure a uniform distribution and/or a selectively controlled flow of the liquid media. Here, for example capillary stop valves are provided for controlling liquid media and shut-off valves are provided for controlling gaseous media.

Via microfluidic channels 43 and 44, the functional regions 41 and 42 are provided with the connecting region 16. It is to be understood that the channels 43 and 44 may comprise several parallel microfluidic channels running fluidically separate from one another, so that via the connecting region 16, various media, especially gases, substances and liquids, can be led into and out of the sample arrangement region 31.

The connecting region 16 contains connecting elements (not shown), which serve for the supply/removal of liquid media, for example for transporting the biological sample or test substances, and gaseous substances, for example process gases and aerosols. These connecting elements may also include pipetting openings for gravity-driven flow, which are operated by pipetting systems.

Moreover, connecting elements for transmitting electrical signals and for optical signals transported via optical fibers or membranes for transmitting pressure or acoustic vibrations are provided in the connecting region 16.

Between the connecting region 16 and the microfluidic functional region 41, another functional unit 45 is provided in channel 43, which functional unit may be for example a bubble trap and ensures that no gas bubbles get through into the sample arrangement region 31, because these would hamper the distribution of liquid medium there.

The bubble trap 45 separates gaseous components from the incoming media stream. It may be configured as an active element with vacuum-assisted suction with or without blocking means, and as a purely passive element with special membranes.

The electrodes 36 and 37 are connected via electric lines 46 and 47 to electrical functional regions 48 and 49, each of which is connected via single or multiple electric lines 51 and 52 to the connecting region 16.

The electrical functional regions 48 and 49 serve for actively controlled or passive distribution and collection of electrical signals.

Moreover, in the sample channel unit 15 or the sample arrangement region 31, various optically sensitive, electrical, electrochemical or biosensor functional elements 53, 54 and 55 are provided, via which optically sensitive, electrical or chemical signals are taken for verification, control or measured value acquisition and are provided at the connecting region 16.

These local sensors in the sample arrangement region 31 and in the sample channel unit 15 make it possible to obtain measured values for making statements about the vitality of cells flushed into the sample channel unit 15 and/or assembled in the sample arrangement region 31. For this, for example integrated sensors 53, 54, 55 are used, with which for example the O₂/CO₂ ion concentration, the pH, impedances or metabolic products can be measured.

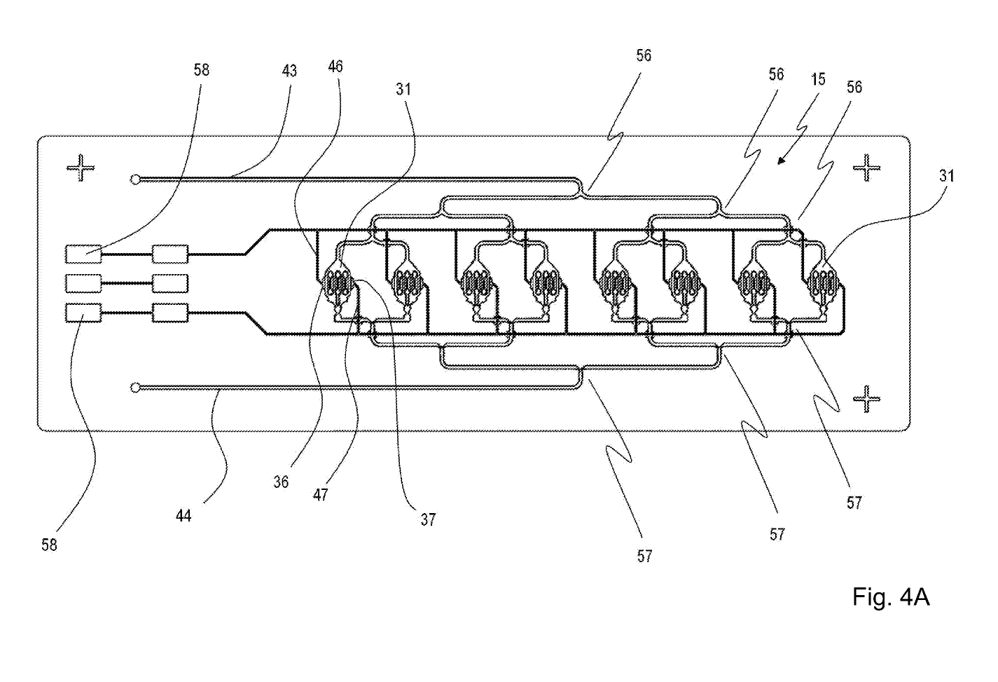

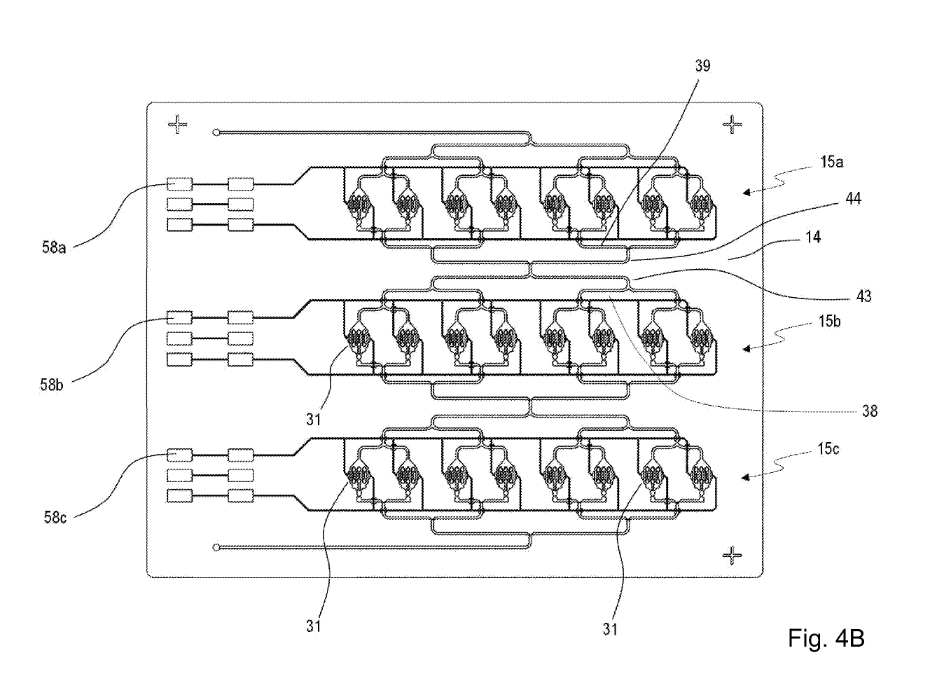

FIG. 4A shows the principle structure of a sample channel unit 15, in which altogether eight sample arrangement regions 31 are connected fluidically and electrically in parallel. For this purpose, a microfluidic supply channel 43 is split multiply by means of splitting locations 56.

Correspondingly, the microfluidic outlet channel 44 is connected fluidically via combining locations 57 to the sample arrangement regions 31.

FIG. 4A also shows the electrodes 36 and 37 of the individual sample arrangement regions 31, which are connected electrically in parallel and are controlled via common connecting elements 58.

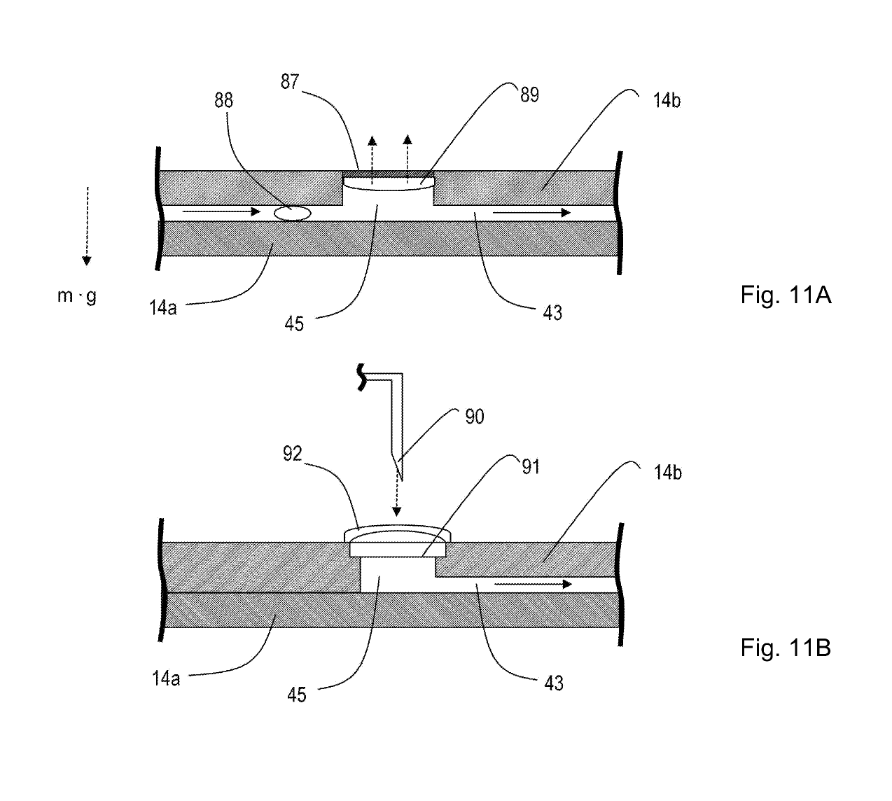

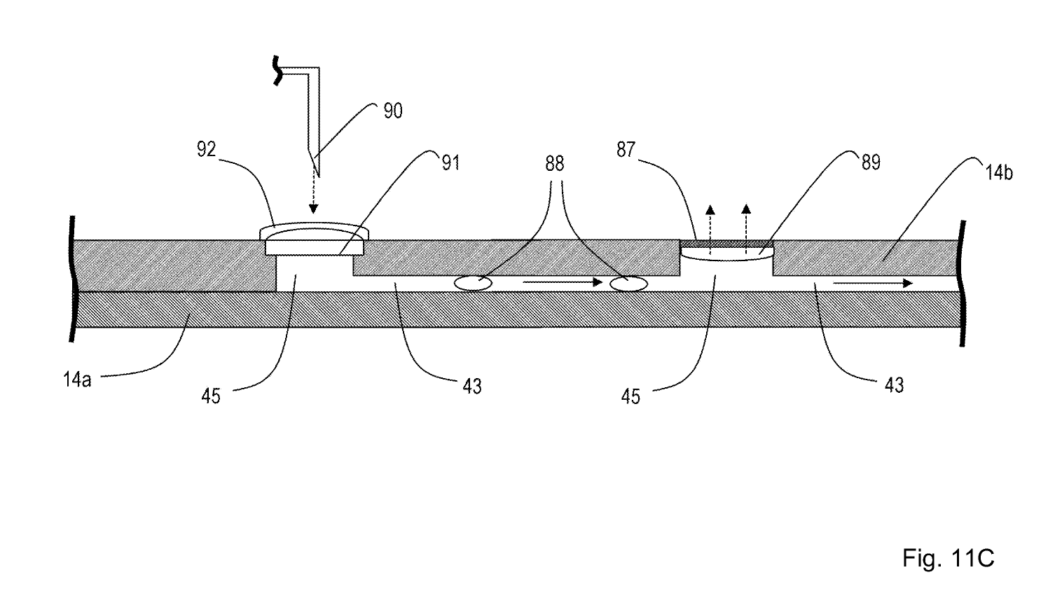

FIG. 4A does not show the top cover, which fits on the carrier substrate 14a of the sample chip 14 and covers the microstructures that are open at the top. Production of a covered microfluidic system of this kind is described in DE 10 2008 018 170 A1, mentioned at the outset, to the contents of which reference is made hereby. FIG. 11A below shows a cross-sectional view through a sample chip 14, in which the carrier substrate 14a and a channel cover 14b can be seen.

This cover 14b is configured optically thin at least in some regions, so that the sample material in the sample arrangement region can be analyzed by optical methods.

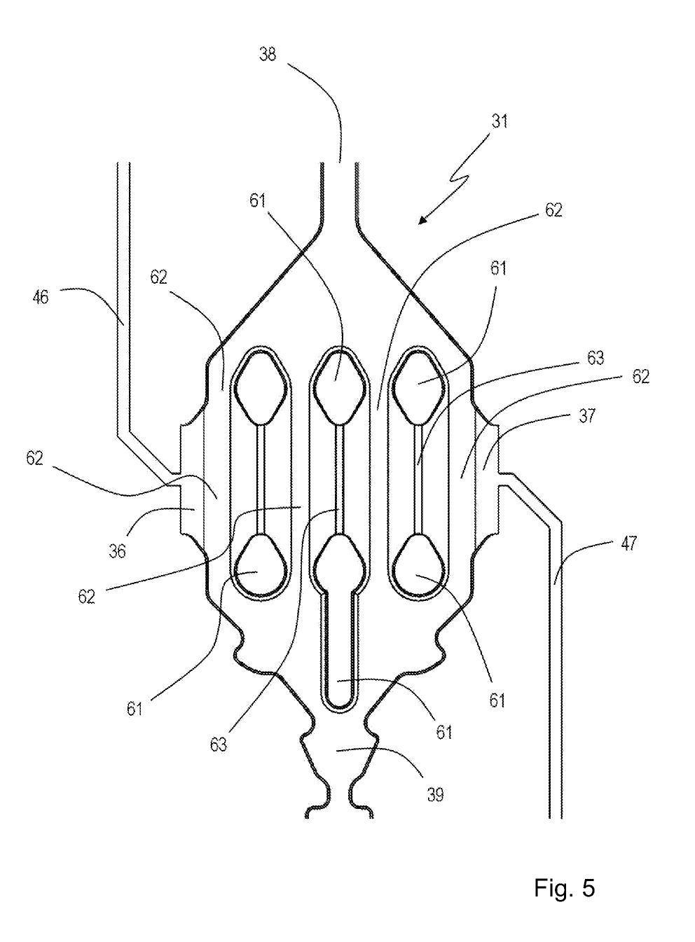

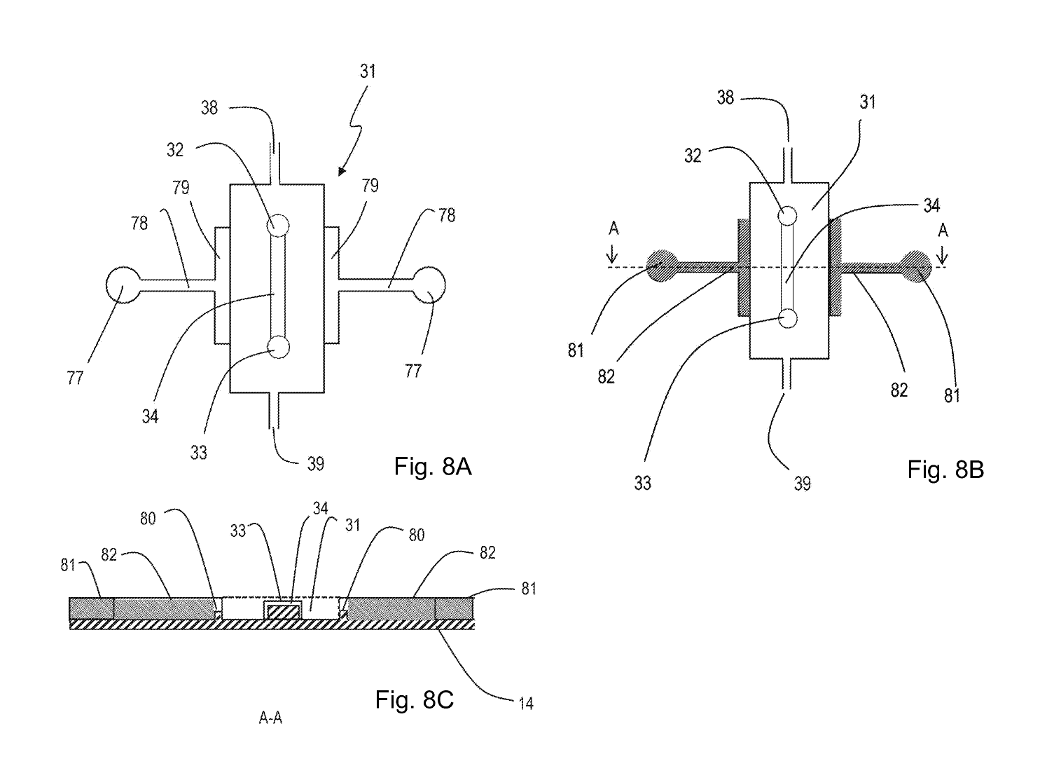

FIG. 5 shows an enlarged top view of a sample arrangement region 31, which consists of several webs 61 and microfluidic channels 62, which are arranged between the electrodes 36, 37 and are connected together via openings 63. The webs 61 and the openings 63 are examples of the webs 32, 33 and the gap 34 from FIG. 3; see also FIG. 8C.

The sample arrangement region 31 is a specially formed region of the sample channel unit 15, in which the biological sample material 35, especially biological cells and cell constituents, can be arranged in a selected fashion under the action of external forces, especially electric field strength or flow conditions.

Between the webs 61, the openings 63 are provided, in/at which biological sample material can be assembled under the action of electric fields that are generated by the electrodes 36, 37, as is described in DE 10 2008 018 170 B4 and in DE 10 2009 039 956 A1, mentioned at the outset.

By structuring the channels 62 and webs 61, the electric field existing between the electrodes 36, 37 can be manipulated in its action so that the field strength is selectively increased or attenuated in the region of the openings 63, in order to exert an influence on assembly of the biological sample material 35.

The surfaces of the webs 61 and channels 62 can be selectively modified, in order to create an environment corresponding to the natural environmental conditions for the respective biological sample. These modifications may comprise hydrophilization or hydrophobization of the relevant surfaces.

Moreover, the flow velocity is influenced by the geometry of the webs 61 and channels 62, to support assembly of the biological sample. For example, regions with gentler flow can be created by means of increases in cross section in the channels 62.

The electrodes 36, 37 are specially structured, conductive surfaces, which on the one hand, by applying DC or AC voltages, generate electric fields for influencing assembly of the biological sample material.

On the other hand the current flow measured on applying DC or AC voltages allows conclusions to be drawn regarding the impedance of substances in the sample arrangement region 31, so that the electrodes 36, 37 also act as sensors. Moreover, via the electrodes 36, 37, electrical pulses can be produced, with which the cells assembled in the sample arrangement region can be disrupted.

With parallel connection of in this case eight sample arrangement regions 31, identical sample material can be tested with different substances in one sample channel unit 15. Alternatively, different biological sample material can be assembled in the different sample channel units 15 and tested with the same substance, which is supplied through the feed channel 38.

It is also possible to connect two or more sample arrangement regions 31 or sample channel units 15 in series on one sample chip 14, so that the outlet channel 39 of a first sample arrangement region 31 in the direction of flow leads into the feed channel 38 of a fluidically downstream sample arrangement region 31. The electrodes 36, 37 of the two sample arrangement regions 31 are then controllable and readable independently of one another. FIG. 4B shows a sample chip 14, on which 3 sample channel units 15a, 15b and 15c are connected in series with one another.

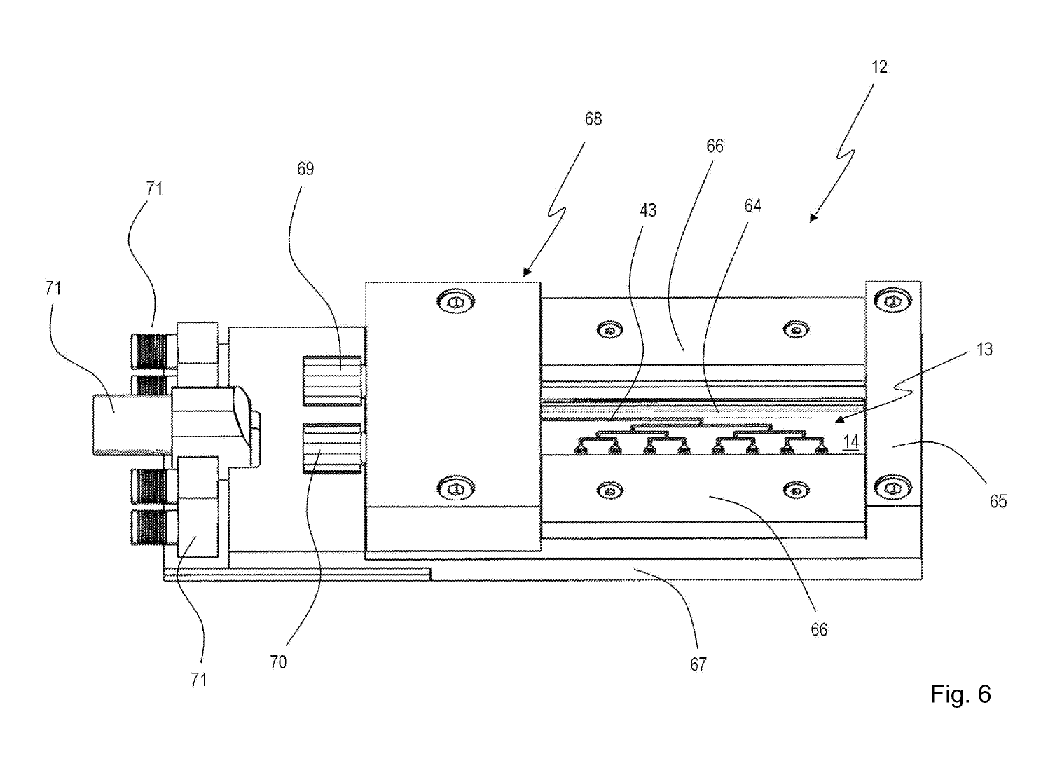

FIG. 6 shows a perspective top view of an embodiment for the connector plate 12 from FIG. 1.

On the right in FIG. 6, in the receiving region 13, a sample chip 14 can be seen, on which there is an optically thin cover plate or cover film 64, which is clamped together with the sample chip 14 by means of clamping elements 65, 66 on a carrier 67 of the connector plate 12.

On the left, next to the sample chip 14, there is a fluidic block 68 that serves for fluidic connection, in the present case comprising a feed element 69 communicating with the feed channel 43 and an outlet element 70 communicating with the outlet channel 44, not shown in FIG. 6.

On the left, outside at the connector plate 12, electric connecting elements 71 can be seen, which communicate with lines 46, 47.

The elements 69, 70, 71 are external connecting elements 23 of the connector plate 12.

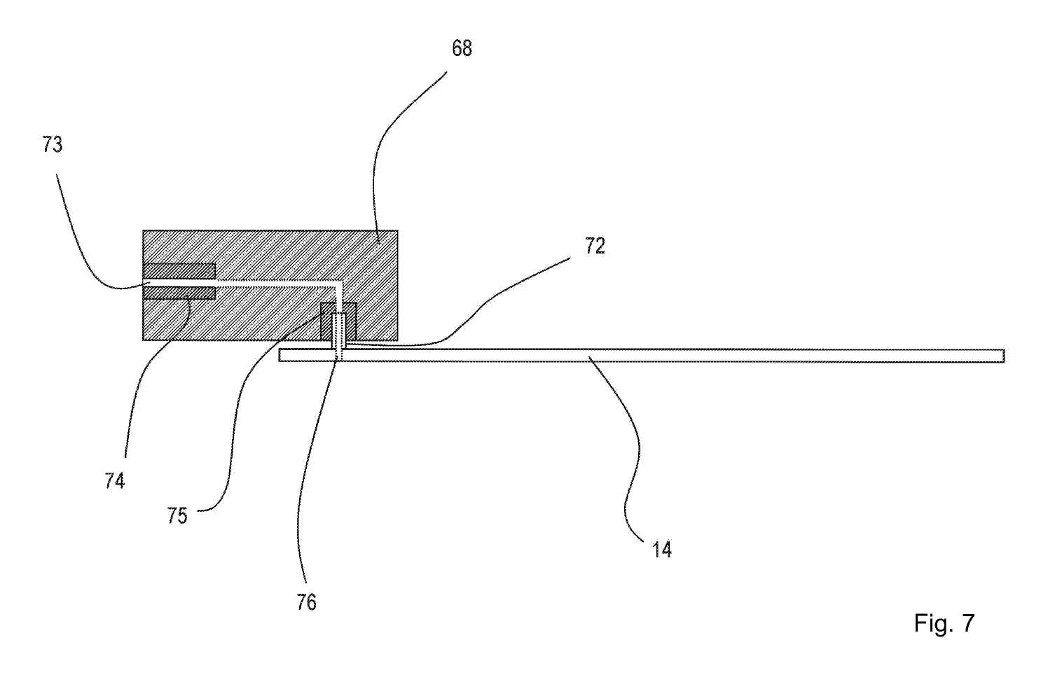

FIG. 7 shows a longitudinal section through the fluidic block 68 of the connector plate 12 from FIG. 6, showing the fluidic contacting of the sample chip 14. The fluidic block 68 serves for receiving sealing elements and connecting channels. It is made for example of polycarbonate or polymethylmethacrylate.

72 denotes a vertical connection, configured as a connecting olive, on the sample chip 14, and 73 denotes a channel structure serving for connecting to the external connector, surrounded on the end with a sealing element 74, which serves for connecting feed and outlet elements 69, 70 and can be configured as a screw connection or clamp connection.

A comparable sealing element 75 is assigned to the vertical connector 72, which makes the connection to the channel structures 76 on the sample chip, which is formed for example by the feed channels 38 and outlet channels 39.

The element 75 corresponds to one of the internal connecting elements 21 of the connector plate 12 shown in FIG. 1. The elements 72, 76 are an example of the connecting elements 18 of the sample chip 14 shown in FIG. 2.

While the electrodes 36 and 37 can be formed by gold electrodes, FIGS. 8A-8C show an embodiment in which the electrodes are formed by conductive ter-polymer, as is described for example in not pre-published DE 10 2012 102 321.

In this way, the problems connected with the production of gold electrodes with respect to exact positioning of the mask for the electrodes are avoided. The polymer electrodes are formed by introducing polymerizing monomers into corresponding micro-channels, as is for example described in detail in not pre-published DE 10 2012 102 321.

Accordingly, the electrodes are configured as solid electrolyte, which comprises a polymer matrix, which is produced by polymerizing a monomer solution, which has at least one monomer, optionally at least one crosslinking agent, and at least one directly polymerizable ionic liquid, which has an organic charge carrier, preferably organic cation, and an inorganic counter-charge carrier, preferably an inorganic anion, wherein the organic cation preferably has at least one allyl residue, more preferably at least one quaternary nitrogen.

A directly polymerizable ionic liquid is an ionic liquid that can be used without prior derivatization of the organic charge carrier.

For production of the electrodes, a monomer solution is used, in which firstly three monomers are present in an organic solution, for example isopropanol. The monomer solution consists of a simple acrylate (simple chains), which when polymerized alone yields linear chains and represents the basic structure of the polymer (here: HEMA—2-hydroxyethyl 2-methylprop-2-enoate). Then there is a bisacrylate (here: EGDMA—2-(2-methyl-acryloyloxy)ethyl-2-methylacrylate), which provides the crosslinking (doubled, linked chains). As the last monomer, an unsaturated ionic liquid (here: AlMeImCl—1-allyl-3-methylimidazolium chloride) is added. This consists of chloride ions and a large, positively charged organic cation. In one embodiment the monomers are polymerized to a ter-polymer by controlled free-radical polymerization using a UV initiator (here: Irgacure2959—2-hydroxy-4′-(2-hydroxyethoxy)-2-methylpropiophenone).

Alternatively it is also possible, as electrode polymer, to fill the micro-channels 77, 78, 79 with an electrically conductive monomer solution and leave it to harden.

FIG. 8A shows a schematic top view of a sample arrangement region 31 with webs 32, 33 and gap 34 and microfluidic feed channel 38 and outlet channel 39. 77 denotes inlet openings for the electrode polymer, which communicate with transferring channels 78, which lead to structuring regions 79, in which the polymer electrodes are formed.

FIG. 8B is similar to FIG. 8A, but with micro-channels 77, 78, 79 filled with electrode polymer. FIG. 8C shows a sectional view along line A-A from FIG. 8B, in which vertical capillary stops 80 for the electrode polymer can be seen. The capillary stops 80 serve for guiding the filled electrode polymer along the structuring region 79, so that electrode polymer cannot get into the sample arrangement region 31.

81 denotes contact surfaces for external contacting formed in the inlet opening 77, and 82 denotes the polymer electrode formed in the structuring region 79.

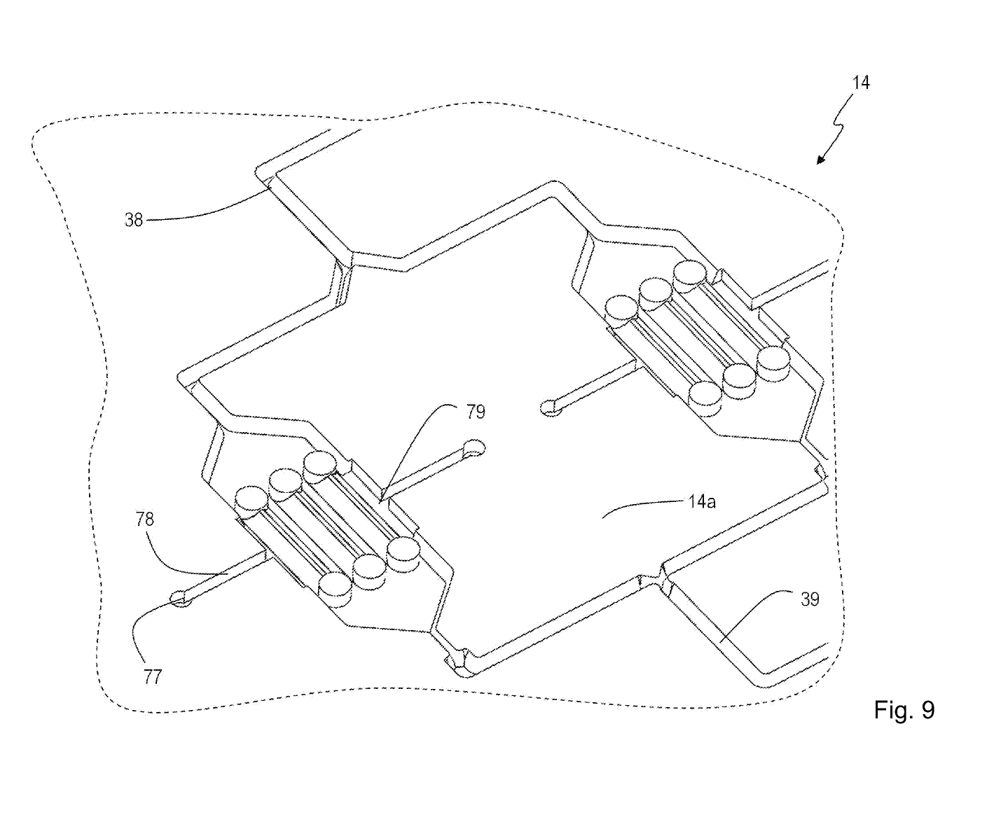

The micro-channels required are produced together with the other micro-structuring of the sample chip by the injection molding process, so that metallization is unnecessary. FIG. 9 shows a detail of an example of a sample chip 14, in which the microfluidic channels 38, 39 were produced together with the micro-channels 77, 78, 79 and the rest of the micro-structuring in an injection molding manufacturing step.

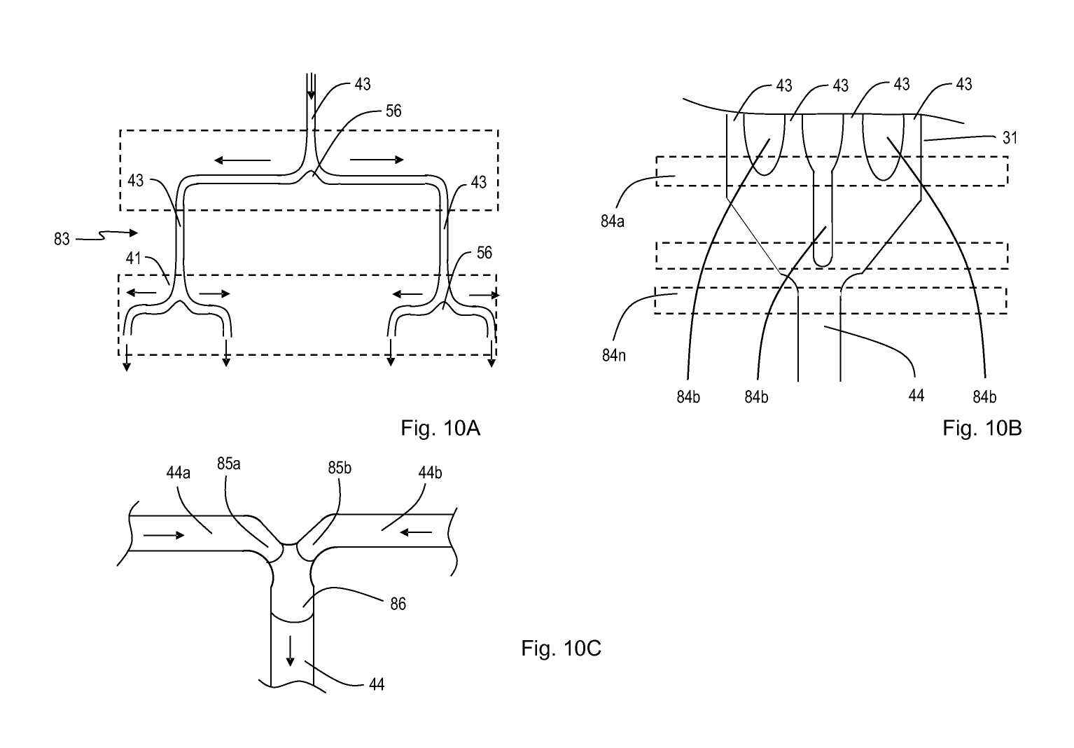

FIGS. 10A-10C show examples of various valve systems and splitting locations, which ensure that all microfluidic channels 43, 44 in the sample channel unit 15 shown in FIGS. 4A-4B are filled with liquid.

In microfluidic sample chips 14 made of hydrophobic materials with several branching micro-channels 43, 44, uniform filling of all micro-channels 43, 44 is often a problem owing to the high surface tension; see FIG. 10A. Especially when the micro-channels 44 are merged together again, air bubbles may be trapped, and their subsequent removal is barely possible.

By concatenation of a cascade of multiplexer structures and capillary stop valves with increasing burst pressure it is nevertheless possible to fill a sample chip of this kind 14 without air bubbles.

A cascade 83 consists of one or more multiplexers (FIG. 10A), on which the micro-channels 43 are separated by means of the splitting locations 56. A splitting location 56 splits an incoming liquid stream on its interface into two new interfaces, but without being subject to abrupt pressure changes. FIG. 10A shows a possible embodiment of such a functional region.

Furthermore, cascaded capillary stop valves (FIG. 10B) are provided for uniform filling of the micro-channels 43, 44 and the sample arrangement regions 31. In this case a liquid stream with its interface first stops on a capillary stop valve of a first cascade stage 84a, which contains obstacles to flow 84b, on which the micro-channels 43 are merged. It is not until liquid streams from all micro-channels 43 of a sample arrangement region are at the capillary stop valves of the first cascade stage that the burst pressure is exceeded and the meniscuses of the individual interfaces are merged. This operation is repeated for the next cascade stages until the liquid streams of all sample regions are at the last cascade stage 84n.

Furthermore, one or more merger valves (FIG. 10C) or cascades of merger valves are provided, at which the micro-channels 44a, 44b are merged again. The merger valves do not “switch” until liquid streams from both micro-channels 44a, 44b are present and the liquid meniscuses 85a, 85b touch one another, thereby forming a single daughter meniscus 86 with larger radius and therefore lower burst pressure (p is proportional to γ/2R, with γ=surface tension of the medium, R=radius of curvature of the meniscus).

Valves that may be used are described for example in EP 1 441 131 A1 and U.S. Pat. No. 6,601,613 B2.

FIGS. 11A-11C show examples for ensuring bubble-free filling of the microfluidic channels 43. In FIG. 11A, 45 denotes a functional unit configured as a bubble trap.

Moreover, in FIG. 11A, 14a denotes the carrier substrate and 14b denotes the channel cover for a micro-channel 43.

If air bubbles 88 get into a microfluidic sample chip 14, generally the latter is no longer operational. In addition, air bubbles 88 may damage the cells in the sample chip 14. Therefore the actual fluidic system may be preceded by at least one bubble trap 45. This may be integrated directly in the sample chip 14 or in the connector plate 12, as is shown for example in FIG. 11A and 11C.

For this, for example according to the cross-sectional view in FIG. 11A, a gas-permeable membrane 87 is provided, which is housed in a recess in the channel cover 14b. In a hollow on the channel cover 14b, air bubbles 88 from the channel 43 are captured and the gas 89 escapes through the membrane 87. In this embodiment it is a purely passive bubble trap. If in addition supporting vacuum suction is used, it is an active bubble trap.

Furthermore, parallelized interconnections and cascades of these passive bubble traps are conceivable.

As already mentioned, either a dielectrophoresis unit or a perfusion unit is used as control unit 11. Thus, whereas collection of the cell culture only takes a few minutes, culture of the cells should take place over several weeks. If both are carried out with the same control unit 11, this is blocked for several weeks, before assembly of cells can take place again.

The dielectrophoresis unit controls the priming of the chip, collection of the cells by dielectrophoresis and construction of the cell culture. The perfusion unit then takes care of supply of the cell culture with medium and controls the incubation with test substances over the culture time of days to weeks.

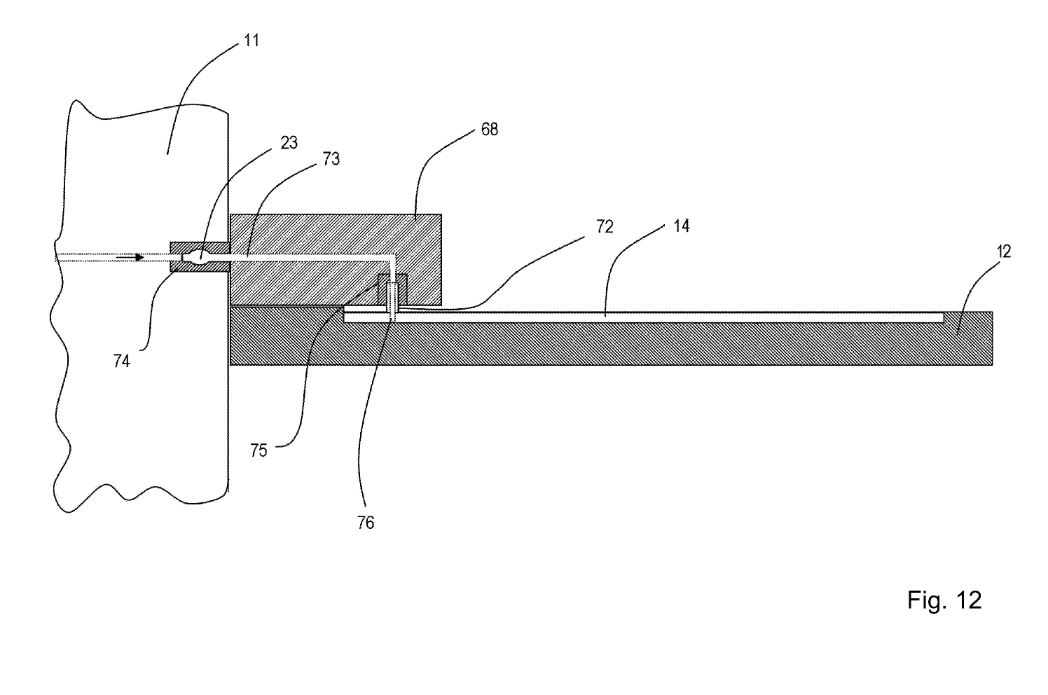

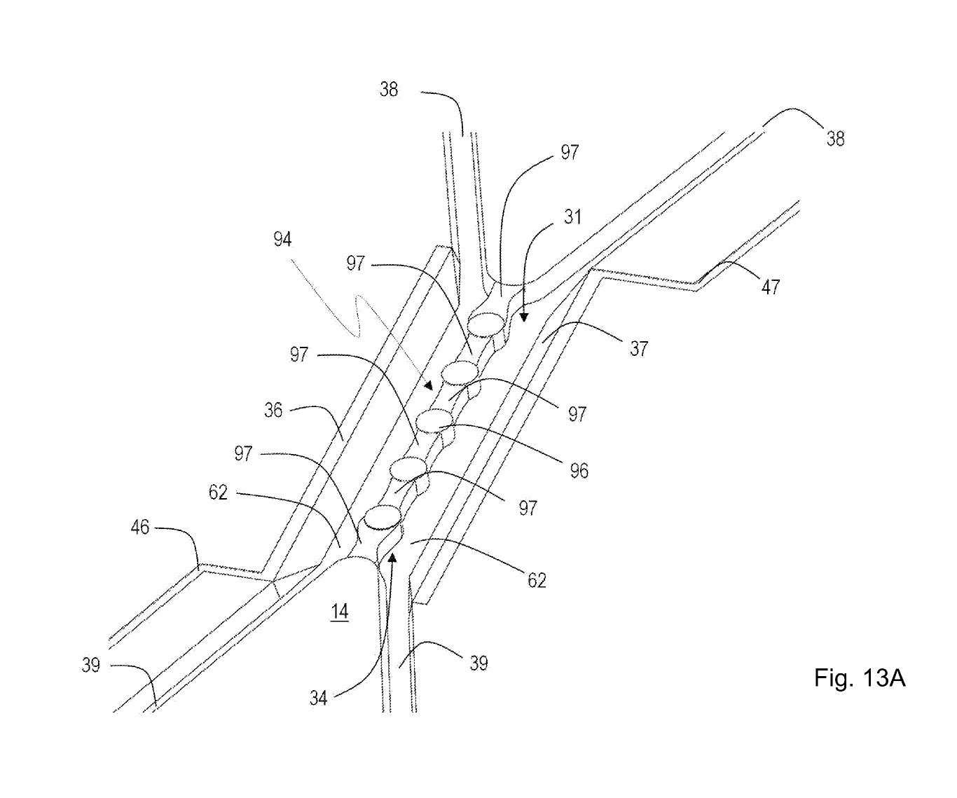

The contacting of the sample chip 14 to the two control units 11 takes place via the connector plate 12 and must allow bubble-free and contamination-free recoupling, i.e., disconnection and later reconnection of the sample chip from one control unit to another. These manipulations lead almost inevitably to ingress of air bubbles 88 from the external connecting elements 23 of the connector plate 12 into the sample chip 14; see FIG. 12. However, these air bubbles disturb the flow, for example by altering the flow resistance in the affected channel segment, and destroy the cell culture if they get into the sample arrangement regions.

The contacting can take place according to FIG. 11B via a septum 91 on the sample chip 14 or the connector plate 12, wherein connection to the control unit 11 is made with a hollow needle 90. The hollow needle 90 can be a component of the control unit 11 but it can also be a component of the connector plate 12.

However, air-bubble-free recoupling preferably takes place via a microfluidic venting device according to FIG. 11A extended by a septum 91 according to FIG. 11B, as shown in combination in FIG. 11C. Via the hollow needle 90, during coupling or recoupling, air bubbles 88 entering the micro-channels 43 are ejected again in the downstream bubble trap via membrane 87.

The septum 91 can be protected against contamination, preferably by a blister film 92, which covers the septum 91 at least partially.

The coupling of the connector plate 12 to the control units 11 can take place via feed elements 69 and outlet elements 70 as combinations of hose and screw connections. Degassing takes place as already mentioned above.

However, coupling of the connector plate via a plug-and-socket system is preferred, as shown for example in FIG. 12, in which recoupling of the sample chip can be performed entirely without hose material.

FIG. 12 shows a sectional view of the coupling of a sample chip 14 clamped on a connector plate 12 to a control unit 11 via the fluidic block 68 known from FIG. 7 and external connecting elements 23. The sealing element 74 is seated here in the control unit 11, and a connecting element 23 is plugged and sealed in this sealing element 74. Connection of the fluidic block 68 to the sample chip 14 takes place as in FIG. 7, and venting as in FIG. 11A.

Integration of the functional elements 41, 42, 45, 48, 49, 53, 54, 55 in the individual sample channel units 15 makes monitoring of various parameters possible, for example electrode function, filling and freedom from air bubbles of the sample chip 14, flow rates, temperature, gas content of the media, cell culture density and cell count etc., without visual monitoring and manual steps being required.

Suitable measuring principles for this are for example impedance measurement for flow rates, air bubbles, cell density and control of cell assembly, and optical/electrochemical O₂/CO₂ sensors, temperature sensors and strain gauges for detection of flow rates and air bubbles.

Moreover, optoelectronic sensors or micro-optical or optofluidic methods may be used, as described for example in US 2011/0181884 A1.

Impedance measurements can also be taken via the electrodes 36 and 37.

The functional elements 41, 42, 45, 48, 49, 53, 54, 55 described thus far serve for quality assurance, i.e., the functionality of the sample chip 14, monitoring of cell density and also in particular calibration of the complete system.

Furthermore, the functional elements can also be used for measuring cell reaction, thus for example for measuring vitality or activity when chemicals or medicinal products are supplied.

Whereas in the prior art, measurement of cell response has up to now been performed visually by fluorescence microscopy and chemically by analysis of the perfusate, the integrated sensors, i.e., the functional elements 53, 54, 55, allow less complex and therefore less expensive and in particular continuous measurement of the cell reactions.

For example, cellular vitality can be determined by measuring the oxygen content in the medium before and after the medium passes through the sample arrangement regions 31.

Measurements of the impedance of the cell arrangement in the sample arrangement region 31 for example give an indication regarding the tightness of tissue barriers, such as are present for example in the blood-brain barrier, in the intestine or in the kidney.

The continuous measurements of ion concentration, pH or of products of cell metabolism in the medium performed on the sample chip 14 directly, i.e., as it were on-line, provide information directly concerning the functionality of the cells, without having to capture and analyze the medium after the sample chip 14. These measurements can be performed electrochemically or with biosensors that use immobilized antibodies and/or enzymes.

In order to be able to construct more complex, asymmetric tissue structures such as for example endothelial barriers of the intestine or of the blood-brain barrier, it is envisaged according to the invention to arrange a separating structure 94, which may be configured as hydrogel 97, in the region of the gap 34, thus in the region between the micro-channels 62, where the biological sample material 35 is arranged.

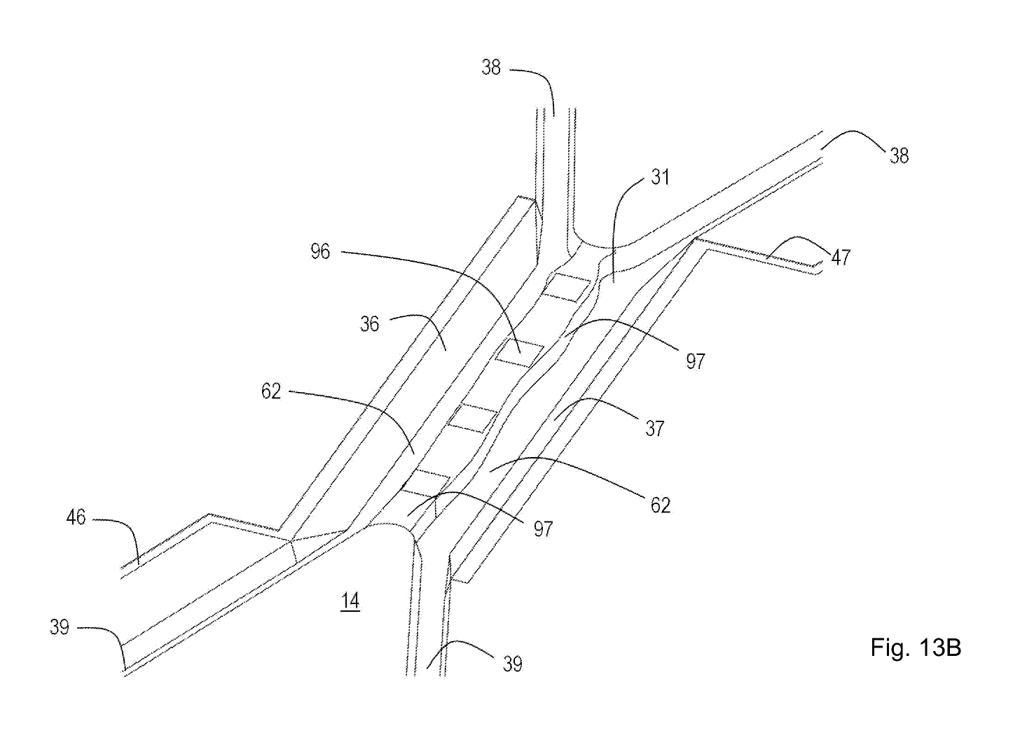

The hydrogel can be arranged between posts 96, which are provided in the gap 34, as is shown in FIGS. 13A-13B, where the hydrogel covers the gap 34 and covers the posts 96 partially according to FIG. 13A or completely according to FIG. 13B.

Hydrogels that may be used are described for example in DE 10 2007 034 580 A1 and DE 10 2007 051 059 A1, so that these documents are to be referred to for further information.

The hydrogels introduced in the region of the dielectrophoresis-assembly regions, i.e., the openings or gaps 34, stabilize the cell structure, and extracellular matrix proteins can be added to them, as is the case for example for the basal membrane in the blood-brain barrier and the blood-air barrier in the lung.

Complex, asymmetric structures are produced by assembly of different cell types on different sides of the hydrogel. For example, endothelial cells can be established on one side and astrocytes on the other side.

By using a soluble hydrogel, direct contact can be provided between the cells after assembly. For this, the hydrogels for example have crosslinks that can be cleaved by metalloproteases. The use of alginate gels, which can be dissolved by adding Ca²⁺ complexing substances such as EDT or citrate, is also conceivable.

Another possibility for constructing asymmetric structures consists of connecting two separate channels by a micro-capillary array, as is already described in principle in DE 10 2008 018 170 B4. If a dielectrophoretic field is applied via such an array of micro-openings, in each case only cells flushed in through one of the channels are collected, so that an asymmetric cell structure can be produced.

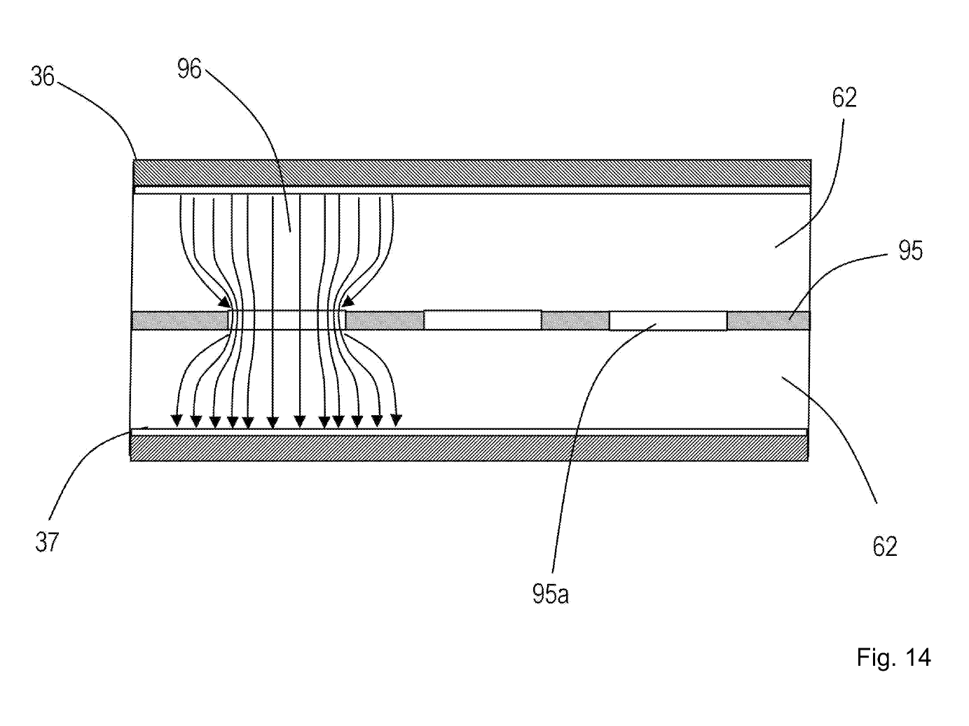

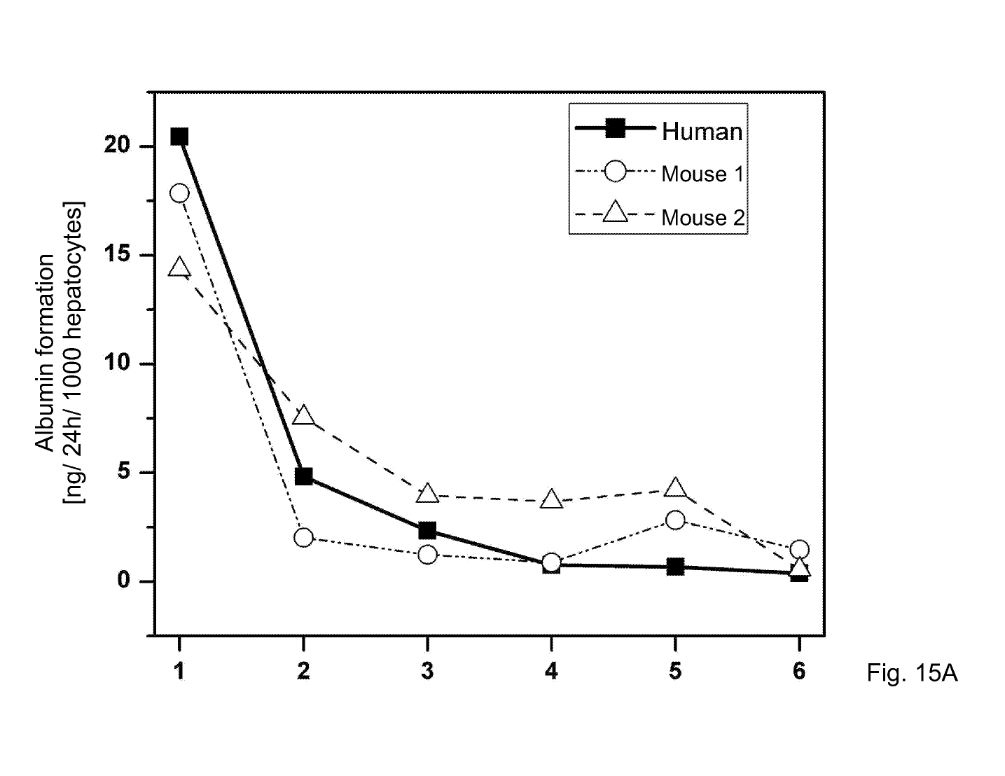

Instead of a micro-channel array of this kind, an isolating membrane 95 with holes 95a may also be used as separating structure 94 between the micro-channels 38, 39, as is shown in FIG. 14. The cells are drawn by the dielectrophoretic field into or onto the holes 95a in the membrane, because when a voltage is applied, these holes 95a also create local field inhomogeneities 96 and therefore dielectrophoretic forces, as can be seen in FIG. 14, which shows an embodiment for collection of complex arrangements of cells in a sample arrangement region 31.

For constructing organs that consist of several successive substructures, such as for example the renal corpuscle and the renal tubule in the case of the kidney, the structure of the sample arrangement region known from DE 10 2008 018 170 B4 is not suitable, as the inventors have been able to establish in their experiments.

Organ structures of this kind can only be produced by series connection of two or more sample arrangement regions that are electrically addressable individually and selectively. These sample arrangement regions may have either the same or different microstructures for forming the dielectrophoretic field and position cells in the arrangement suitable for the respective substructure.

Firstly, cells for the first sample arrangement region 31 are flushed into the sample chip 14 and only this first sample arrangement region 31 is provided with a dielectrophoresis voltage, in order to assemble the cells. After thorough rinsing of the sample chip 14, the cells for the second sample arrangement region 31 are then flushed in, the dielectrophoretic field is only applied to this second sample arrangement region 31 and the second substructure is assembled.

With the system according to the invention it is possible for example to establish the following organ and tissue models: endothelial/epithelial layers and barriers for the blood-brain barrier, the kidney, the intestine and the lung; 3D tissue of tumors, metastasis models in liver and intestine and the thyroid. Furthermore, the differentiation of stem cells can be established and monitored.

As already mentioned, the control unit 11 and the connector plate 12 are reusable, whereas the sample chips 14 as a rule are consumables.

The sample chips 14 can be provided in a kit together with other materials, so that they are ready for particular uses. The advantage of such a kit is that all necessary materials together with the microfluidic sample chip 14 are provided as a commercial unit, ensuring compliance with specified standards and purity of the substances.

The components of the kit include, in addition to the sample chip 14: media, reagents, buffers and optionally also cells for the following applications:

Determination of cellular vitality on the sample chip, extraction of nucleic acid of the cultured cells from the sample chip, calibration of the cell culture, cleaning the sample chip on completion of the test, introducing protein coatings and/or hydrogels into the sample chip, assembly of cells, dispatch of pre-cultured sample chips.

In a perfused 3D cell culture it is possible to carry out optical (for example transmitted-light, fluorescence, Raman, SERS, FIB/SEM), electrical (impedance, electrochemical sensors) and biochemical (analysis of the perfusate e.g., by HPLC/MS) methods of analysis.

### Examples of Assays to be Carried Out

### a) Determination of Nucleic Acids in the Cells

In this assay, the cells must be lysed and DNA/RNA must be extracted from the sample chip, and then the nucleic acids are analyzed further by suitable analytical techniques, for example microarrays, bead arrays, PCR or sequencing methods and methods using mass spectrometry.

The purpose of this assay is on the one hand extraction of the DNA, for analyzing genetic features/changes of the cells, for example mutations in tumor cells or cell lines. On the other hand, by determining the amount and type of RNA in the cells, information may be obtained on the upregulation or downregulation of genes. These assays serve for example for analyzing the reaction of the cells to particular substances.

For this, the cells are lysed either chemically with suitable substances or electrically by means of electrodes integrated in the sample chip. Then the cell constituents are rinsed from the sample chip and the nucleic acids can be amplified and/or analyzed by standard methods.

The sample chip offers the advantage that only very small amounts of reagents are required for cell lysis, or reagents may even be completely unnecessary, when the cells are lysed by applying a low-frequency voltage (<100 kHz) to the electrodes already present in the sample chip.

This lysis performed on the sample chip offers numerous advantages: Owing to the rapid disruption of the cells, degradation of proteins, DNA and RNA is minimized to the greatest possible extent. Chaotropic reagents such as SDS or urea, which generally have a disturbing effect on subsequent assays, are completely unnecessary. For inactivation of nucleases and proteases, in addition enzyme inhibitors can be added to the buffer solution.

### b) Determination of Enzyme Activities of the Cells

For example, determination of metabolic enzyme activity in cells may be considered. In the case of the liver, this would be for example cytochrome P450 enzymes (CYP), which mainly catalyze the metabolization of extraneous substances, such as medicinal products, in the body. Generally they are oxidation reactions, in which oxygen atoms are integrated into the metabolized substance.

The enzyme activity in the cells is determined by determining the concentration of cellular products (e.g., albumin in the case of liver cells) directly in the perfusate, or by measuring the conversion of an enzyme substrate by the cells. In the second case the cells are incubated with substrates of the enzymes to be analyzed (e.g., testosterone for determining the CYP 3A4 activity of liver cells), the perfusate is collected and the concentration of the degradation products in the perfusate is determined (e.g., 6β-hydroxytestosterone, which is formed by CYP3A4 from testosterone). The cellular products can be detected e.g., using immunoassays (e.g., enzyme-linked immunosorbent assays for quantifying the albumin concentration) or by chromatography (e.g., high-performance or ultra-performance liquid chromatography HPLC, UPLC) or mass spectroscopy.

The purpose of this assay is to monitor the metabolic function of cells involved in metabolism, for example the liver cells, so as to be able to detect any changes as a reaction to the substances supplied.

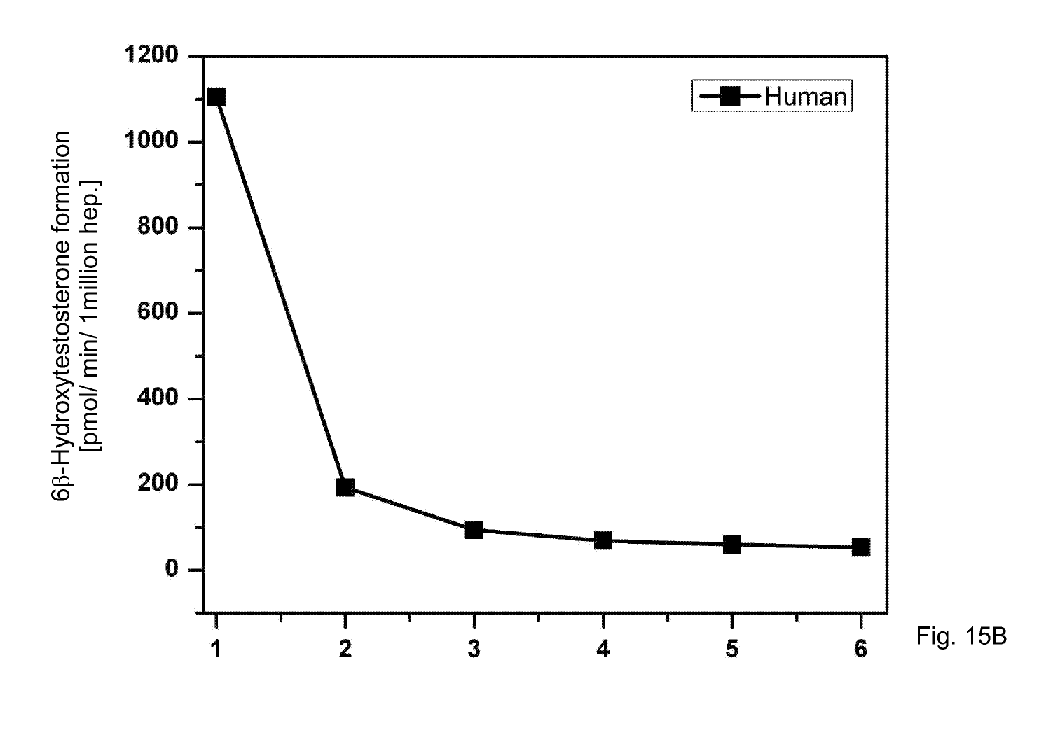

FIGS. 15A and 15B show, as typical applications, in each case results from experiments carried out with the sample chip to study the decline in albumin synthesis rate and the CYP3A4 activity in an organ-like liver cell culture incubated with high concentrations of active substance. Days of incubation are shown on the abscissa.

FIG. 15A shows measurements of the albumin concentration from 3 different experiments with human or mouse hepatocytes. The cells were incubated permanently with 200 μM, phenacetin, 200 μM testosterone and 100 μM 7-hydroxycoumarin at a flow rate of 3 μl/min.

FIG. 15B shows measurements of the 6β-hydroxytestosterone concentration in an experiment with human hepatocytes. The cells were incubated permanently with 200 μM phenacetin, 200 μM testosterone and 100 μM 7-hydroxycoumarin at a flow rate of 3 μl/min. This measurement shows the activity of the cytochrome P450 3A4 enzyme, which catalyzes the conversion of testosterone to 6β-hydroxytestosterone.

In this type of assay, the sample chip offers the advantage that only small amounts of reagents have to be used. In addition, with continuous perfusion, the concentration of substrate on the cells is kept almost constant, whereas the metabolic products are led away continuously by the flow of media, as in the body. It is therefore not possible for saturation with product to occur, which would influence cellular activity unnaturally.

### c) Determination of the Toxicity of Substances

This assay concerns determination of toxicity for example with repeated doses and determination of dose-time profiles, for which the cells are incubated with test substances that are supplied in defined time intervals and concentrations. Cellular vitality, cellular activity and changes of the cell contents—for example changes of the genome or proteome—are determined as a function of time.

The purpose of this assay is to detect, in toxicity analyses with repeated incubation, long-term effects that may arise through repeated ingestion of substances. In this way it is possible to measure both short-term acute toxic effects and chronic toxic effects that may arise through longer-term incubation.

For this, the cells are incubated for a longer period alternately with the substances to be analyzed (induction phase) and pure cell culture medium (recovery phase), monitoring the reaction of the cells, especially their vitality and activity. Both the concentrations and the incubation time of the substances can be varied.

Conducting this assay with a sample chip offers the advantage that, owing to the use of the perfused sample chip, substances can be applied continuously in constant concentrations or with defined concentration profiles. It is therefore possible for the first time to include the pharmacokinetic parameters of an active substance in the experiment and thus analyze its toxicity in an experimental situation that comes close to the in vivo situation.

Owing to application of substance concentration gradients over defined intervals of time, it is thus possible for the ingestion of the medicinal product and the concentration profile in the organs to be simulated in the assay.

Concentration profiles for the active substances and other substances can be programmed and controlled in the perfusion unit. Incubation time, flow rate and duration of the recovery phase can also be programmed and controlled via the perfusion unit. This method also makes it possible to perform time-resolved measurements of analytes in the perfusate and correlate them with the substance concentration profile.

### d) Measurement of the Ability of Substances to Pass Through Barriers

In order to measure the qualitative and/or quantitative ability of substances to pass through barriers, the cell barrier is established on the sample chip and incubated with the respective test substance, the perfusates of the sample chip are collected and the concentration of the substance in the perfusate is determined before and after the barrier.

In the body there are various barriers that protect the regions behind them against ingress of undesirable substances; see for example the blood-brain barrier, the blood-intestine or blood-urine junctions, or the air-blood junctions in the nose, bronchi and lungs. This situation is simulated in the sample chip.

On the one hand it is possible to check whether a substance is harmless, because it does not cross the membrane. For example it is possible to check the penetration or non-penetration of environmental pollutants in chemical or particulate form (e.g., nanoparticles). Furthermore, it is possible to test new dosage forms for active substances.

On the other hand, for the application of medicinal products in particular regions of the body it is important that they cross the barrier, in order to reach their site of action. This applies for example to crossing the blood-brain barrier for treatment of brain tumors.

In the sample chip, cell barriers are constructed for this and are incubated with substances. To verify the ability to cross the barrier, the concentration of the substance is measured before and after the barrier. In addition, it is possible to test whether certain substances make the barrier more permeable and thus possibly have harmful effects on an organism.

The sample chip offers the advantage, compared to static models, that it reproduces the natural flow situation in the body, where substances in the blood stream flow past the barrier and do not—as in a static cell culture—act on the barrier in a stationary liquid.

Owing to the small volumes in the sample chip, in addition only small amounts of the substances, often of only limited availability, are required for carrying out a test.

### e) Fixation and Antibody Staining of Cells

On the sample chip, for purposes of immunohistochemistry, proteins can be selectively stained with antibodies and staining reagents.

For this, the cells in question are fixed on the sample chip, for example with alcohols such as methanol or ethanol, wherein the intracellular water is displaced from the cells and replaced with alcohol. This should make the cells durable.

Then the cell membranes are made permeable to antibodies and other substances by adding detergents. The antibodies/staining reagents are then flushed in via the microfluidic channels 38 of the sample chip and the cells are thus incubated with this medium.

Owing to the small volumes of the sample chip, only small amounts of often expensive antibodies are required. Through continuous perfusion, more antibodies come in contact with the cells in a short time, so that the staining time is shortened compared to static cell cultures.

### f) Fixation and Embedding of Cells

Cells for analyses by invasive methods, for example for electron microscopy, can also be prepared on the sample chip.

All reagents are supplied via the microfluidic channels of the sample chip. First, the cells are fixed in the sample chip, for example with methanol. As preparation for electron microscopy, the cells are then dried, for example by replacing the water with ethanol, and incubated with a contrast agent, for example osmium tetroxide. Then the cells are embedded in a matrix. This differs depending on the subsequent test method, for example paraffin is used for tissue sections and epoxy resin for electron microscopy. This embedding is effected by flushing paraffin or epoxy resin through the microfluidic channels to the cells. Following this embedding, the cover of the sample chip is removed, the cells embedded in the matrix are taken, cut, and the sections are examined correspondingly.

### g) Calibration of the Sample Chip

Before cell function assays such as toxicity, vitality or enzyme activity can be carried out, the initial functionality of the cells can be determined.

For this, one of the sample channel units 15 on the sample chip 14 is used as a reference channel. Here, the function of the cells is monitored without the influence of the substances. For this, established parameters are verified before putting the other sample channel units 15 in function. In addition to verification of cellular vitality, these parameters depend on the type of organ culture; for example albumin production is monitored for a liver culture, and in the case of the blood-brain barrier, the electrical impedance of the cell barrier is monitored.

As can be seen from the above description of the various assays that can be performed with the sample chip or the new system, the new system opens up many new possible applications.

### Application Examples of the Sample Chip

### 1) Toxicity Mechanisms

In this application, the cause of the toxic action of substances is to be determined. For this, the cell culture is incubated with toxic substances and the effect of the substance on various cellular functions is analyzed. These include for example inhibition of enzymes, the triggering of inflammatory reactions or disturbance of cell-cell interactions.

Because it is possible for a cell culture that is very similar to the in vivo culture situation to be established on the sample chip, it is thus possible for the first time to determine the mechanisms of toxicity in a human-like model.

### 2) Formation of Metastases: Migration of Tumor Cells Into “Micro-Tissue”

The new system also makes it possible to establish models for analyzing tumor formation. After an organ culture has been constructed from healthy cells, tumor cells, e.g., circulating tumor cells, are flushed in via the microfluidic channels. The behavior of the tumor cells in the tissue culture is observed with the microscope. For example, penetration into the cell aggregate, displacement of cells or growth of the tumor can be monitored visually.

By means of the electrodes present in the sample arrangement region, penetration of the tumor cells into the organ culture, and thus metastasis, can be promoted by dielectrophoresis.

At the same time, the functionality of the cells can be monitored, using the assay described above under b).

Then both the tumor and the healthy cells can be lysed and their constituents, i.e., essentially the proteins and nucleic acids, can be analyzed; see above, Assay a).

This continuous analysis of tumor development on the same organ culture is possible for the first time with the new system and the sample chip. Cell cultures used until now were not sufficiently like the body for this type of analysis. Furthermore, in animal models it is almost impossible to analyze the development of tumors already in the initial phase or even to monitor this continuously, as observation on the live animal is not possible and therefore tumor genesis can only be observed at various discrete time points—possibly even only in different animals.

### 3) Testing of Active Substances on Oncologic Material/Tumor Model

With the new system it is also possible to analyze the effect of substances on tumor cells. For this, depending on the type of tumor being analyzed, cells are assembled and cultured in a tumor-like structure in the sample chip. The cells are then incubated with drug candidates and their reaction to the drugs is monitored. In this case, in particular the vitality and functionality of the tumor cells and the shrinkage/growth of the tumor are observed.

By culturing the cells as mono- or co-culture in an in vivo-like environment, the reaction of the cells to the drug candidates is more like the real situation than was the case in existing models.

### 4) Interactions of Pathogens With Tissue

The purpose of this application is to analyze the penetration of pathogens, for example bacteria, viruses or parasites, into tissues.

For this, first an organ/tissue culture is established in the sample chip. Then the pathogens are flushed in through the microfluidic channels and their behavior is monitored visually in the cell culture. For example, the penetration into the constructed tissue can be observed. In addition it is analyzed whether the pathogens have an influence on the functionality of the cells in culture. Here, for example, vitality and enzyme activity are verified.

In the sample chip, the penetration of pathogens into a tissue/an organ can be observed continuously. By culturing the cells in an in vivo-like environment, the reaction of the cells to the pathogens is more similar to the real situation than was the case in existing models.

### 5) Mutual Influence of Substances in Their Action

This application analyzes how the toxic effects change with parallel administration of several active substances (drug-drug interaction). For this, the cell culture is incubated with two or more active substances either simultaneously or sequentially and the vitality of the cells is monitored.

Findings concerning drug interactions obtained in animal tests cannot be transferred directly to humans, because substances are often degraded at a different rate in animals. Thus, it is possible that in humans a drug A is degraded faster than a drug B, whereas exactly the opposite occurs in an animal. Therefore animal tests are unsuitable for assessing drug-drug interactions in human patients.

In the sample chip, these interactions can now be tested on human cells and organ-like cell clusters. This situation is more similar to the human situation than existing applications, so that better transferability to the human situation is possible, than in an animal test or in cell tests used until now.

### 6) Mechanisms For the Ability of Substances to Pass Through Barriers

The purpose of this application is to analyze the toxicity of substances based on the behavior of drugs/substances with respect to crossing barriers (blood-brain barrier, intestine, kidney).

The procedure takes place as above in assays c)-e), and the corresponding advantages are obtained.

What is claimed is:

1. A connector plate in a system for carrying out analyses on and/or with biological sample material, said system comprising a control unit, said connector plate comprising:
a mechanical receiving device for housing a microfluidic sample chip, said sample chip configured for arranging thereon and culturing said biological sample material,
external connecting elements provided for detachably connecting the connector plate to said control unit for transferring media and/or signals, and
internal connecting elements provided for detachably connecting the connector plate detachably to said sample chip for transferring media and/or signals.

2. The connector plate of claim 1, which comprises at least one functional element arranged between said external and internal connecting elements.

3. The connector plate of claim 2, wherein said at least one functional element is configured for performing at least one task selected from the group consisting of: the electrical and optical preparation, distribution and merging and interim storage of control and measuring signals; the storage, transport and distribution of liquids and gases; the separating of gaseous constituents from the liquids in active or passive bubble traps; the generating of electrical pulses; the generating of electrical and/or magnetic constant and/or alternating fields; and the transmission of pressure signals.

4. The connector plate of claim 2, wherein said at least one functional element is configured as a sensor selected among an optical sensor, an electrical sensor, a chemical sensor and a biochemical sensor.

5. The connector plate of claim 1, wherein said internal connecting elements are configured for bubble-free coupling of the connector plate to the sample chip and the external connecting elements are configured for bubble-free coupling of the connector plate to the control unit.

6. The connector plate of claim 1, wherein said receiving device comprises clamping elements for mechanically holding said sample chip.

7. The connector plate of claim 6, wherein an optically thin cover is provided in the receiving device.

8. A microfluidic sample chip configured for use in said connector plate of claim 1 and comprising at least one sample channel unit in which a microfluidic sample arrangement region is provided for arranging thereon and culturing biological sample material, said sample channel unit provided with a connecting region for exchanging media and/or signals with said connector plate.

9. The sample chip of claim 8, wherein at least one functional element is arranged between said sample arrangement region and said connecting region.

10. The sample chip of claim 9, wherein said at least one functional element is configured as a sensor selected among an optical sensor, an electrical sensor, a chemical sensor and a biochemical sensor.

11. The sample chip of 9, wherein said at least one functional element is configured to perform at least one task selected from the group consisting of: the electrical and optical preparation, distribution and merging and interim storage of control and measuring signals; the storage, transport and distribution of liquids and gases; the separating of gaseous constituents from the liquids in active or passive bubble traps; the generating of electrical pulses; the generating of electrical and/or magnetic constant and/or alternating fields, and the transmission of pressure signals.

12. The sample chip of claim 8, wherein at least two electrodes are provided in the sample arrangement region, said electrodes configured for generating an electric field.

13. The sample chip of claim 12, wherein said at least two electrodes are configured for impedance measurement.

14. The sample chip of claim 12, wherein said at least two electrodes are configured for generating electrical pulses.

15. The sample chip of claim 12, wherein said at least two electrodes are configured as electrically conducting polymer electrodes.

16. The sample chip of claim 8, wherein at least two microfluidic channels are provided, and wherein in said sample arrangement region at least one gap and a separating structure is provided, said gap delimited by two webs and connecting two microfluidic channels from said at least two microfluidic channels together, said separating structure arranged in said gap.

17. The sample chip of claim 16, wherein said separating structure comprises a membrane with holes.

18. The sample chip of claim 16, wherein said separating structure comprises a hydrogel.

19. The sample chip of claim 8, which comprises a carrier substrate in which said at least one sample channel unit is formed, said carrier substrate sealed with a cover, which is of optically thin configuration at least in some regions.

20. The sample chip of claim 8, which comprises at least one passive bubble trap with a membrane.

21. A system for carrying out analyses on and/or with biological sample material, said system comprising at least one control unit and said connector plate of claim 1 for housing a microfluidic sample chip provided with a sample arrangement region, said biological material to be arranged in said sample arrangement region, said at least one control unit detachably connected to said connector plate for transferring media and/or signals.

22. The system of claim 21, wherein said control unit is configured as a dielectrophoresis unit for priming the sample chip and for collecting the biological sample material in the sample arrangement region.

23. The system of claim 21, wherein said control unit is configured as a perfusion unit for supplying the sample material with medium and for incubation of the sample material over a measuring time period and for acquisition of electrical measured values and/or for sampling for liquid measuring samples.

24. The system of claim 22, wherein said control unit is configured as a perfusion unit for supplying the sample material with medium and for incubation of the sample material over a measuring time period and for acquisition of electrical measured values and/or for sampling for liquid measuring samples.

25. A method of carrying out analysis on and/or with biological sample material in a system that has at least one microfluidic sample arrangement region in which biological sample material is arranged and optionally cultured, comprising:
a) assembling the biological sample material in the sample arrangement region,
b) incubating the sample material with at least one substance, which is supplied via microfluidic channels, and
c) analyzing the sample material.

26. The method of claim 25, in which in step a) at least one organ-like cell culture model is established in the sample arrangement region.

27. The method of claim 25, in which in step c), at least one method of analysis is performed for analyzing a property of said sample material or a change in said property of said sample material, which property is selected from the group consisting of: metabolome; enzyme activity; proteome; genome; gene expression; secretion of markers; morphological phenomenon; cellular vitality; cell organelle function; interaction between cells; interaction between cells and the surroundings in the sample arrangement region; and proliferation.

28. The method of claim 25, wherein in step c) the cells are lysed electrically by means of electrodes integrated in the sample arrangement region.

29. The method of claim 27, in which said method of analysis is selected from the group consisting of: immunohistochemistry; microscopy; electron microscopy; staining of cell constituents; analysis of dissolved constituents by separation techniques; chromatography; electrophoresis; mass spectrometry; colorimetry; immunoassays; nucleic acid analysis; PCR (polymerase chain reaction); FISH (fluorescence in situ hybridization); DNA sequencing; spectroscopy methods; infrared spectroscopy; Raman spectroscopy; NMR spectroscopy; fluorescence spectroscopy; and UV/VIS spectroscopy.

30. The method of claim 25, wherein in step c) qualitative and/or quantitative action of the at least one supplied substance on the sample material is analyzed.

31. The method of claim 25, wherein a comparative analysis is carried out on a sample material that is incubated with said at least one substance, and on a sample material that is not incubated with said at least one substance or is incubated with another substance.

32. The method of claim 25, wherein in step a) a liver-like cell culture model is assembled and cultured, which is incubated in step b) with at least one potentially toxic substance, wherein in step c) the action of said at least one substance on at least one cellular function is analyzed.

33. The method of claim 25, wherein, in step a), tumor cells are assembled in an organ-like cell culture and cultured, which cell culture is incubated in step b) with at least one oncologic active substance, wherein in step c) a change of the cell culture is analyzed.

34. The method of claim 25, wherein, in step a) a biological cell barrier is assembled in an organ-like cell culture and cultured, which cell culture in step b) is incubated on one side of the cell barrier with at least one active substance, wherein in step c) the concentration of the active substance on the other side of the cell culture is analyzed.

35. The method of claim 25, wherein, in step a), biological cells are assembled in an organ-like cell culture and cultured, which cell culture is incubated in step b) with at least one pathogen, and wherein in step c) the reaction of the cell culture to incubation with the at least one pathogen is analyzed.

36. The method of claim 25, wherein, in step a), biological cells are assembled in an organ-like cell culture and fixed, to which cell culture at least one stain is bound in step b), and wherein in step c) the staining is analyzed by optical methods.

37. The method of claim 25, wherein, in step a), biological cells are assembled in an organ-like cell culture and fixed, which cell culture is dried in step b) and incubated with a contrast agent and then embedded in a matrix, and wherein in step c) the cells embedded in the matrix are taken and analyzed.

38. The method of claim 25, wherein, in step a), biological cells are assembled in an organ-like cell culture and cultured, which cell culture in step b) is incubated with tumor cells, and wherein in step c) the behavior of the tumor cells and of the cell culture is analyzed.

39. The method of claim 37, wherein, in step b) the interaction of the tumor cells with the cell culture is promoted by dielectrophoresis.

40. The method of claim 25, wherein, in step a), biological cells are assembled in an organ-like cell culture and cultured, which cell culture is incubated in step b) with at least two active substances, and in step c) the behavior of the cell culture is analyzed.

41. The method of claim 25, wherein, in step a), in a first sample arrangement region, biological cells are assembled in a first organ-like cell culture and cultured, and in a second sample arrangement region, biological cells are assembled in a second organ-like cell culture and cultured.

42. The method of claim 41, in which the first and the second sample arrangement region are connected fluidically in series, wherein in step b) the first cell culture is perfused with at least one active substance, and the second cell culture is perfused with the effluent from the first cell culture, and wherein in step c) the reaction of the second cell culture to perfusion with the effluent is analyzed.

43. The method of claim 25, wherein the system comprises at least one microfluidic sample chip comprising at least one sample channel unit in which the microfluidic sample arrangement region is provided for arranging thereon and culturing the biological sample material, said sample channel unit provided with a connecting region for exchanging media and/or signals with a connector plate.

44. The method of claim 25, wherein the system comprises at least one connector plate comprising a mechanical receiving device for housing a microfluidic sample chip, said sample chip configured for arranging thereon and culturing said biological sample material, external connecting elements provided for detachably connecting the connector plate to a control unit for transferring media and/or signals, and internal connecting elements provided for detachably connecting the connector plate detachably to a sample chip for transferring media and/or signals.

45. The method of claim 25, wherein the system further comprises at least one control unit and a connector plate for housing a microfluidic sample chip provided with the sample arrangement region, said biological material to be arranged in said sample arrangement region, said at least one control unit detachably connected to said connector plate for transferring media and/or signals.
